(19) United States
(12) Patent Application Publication
(10) Pub. No.: US 2025/0295989 A1
(43) Pub. Date: Sep. 25, 2025

(54) VIDEO GAME CONTROLLER

(71) Applicant: Maciej Goralczyk, Kolno (PL)

(72) Inventor: Maciej Goralczyk, Kolno (PL)

(21) Appl. No.: 19/230,876

(22) Filed: Jun. 6, 2025

Related U.S. Application Data
(63) Continuation-in-part of application No. PCT/IB2023/062309, filed on Dec. 6, 2023.

(30) Foreign Application Priority Data
Dec. 9, 2022 (PL) P.443096
Dec. 9, 2022 (PL) P.443097

(51) Int. Cl. A63F 13/24; A63F 13/211; A63F 13/2145

(52) U.S. Cl. CPC A63F 13/24; A63F 13/211; A63F 13/2145

(57) ABSTRACT

A video game controller receives user inputs to control game play. A pair of triggers operate in a user selected mode of operation responsive to a position of a movable input device adjacent to the trigger. The input device position causes positioning of a link which either causes game play inputs corresponding to each trigger position throughout a full range of trigger movement, or more rapid trigger inputs that result from relatively shorter trigger movement to a stop position which causes actuation of a trigger stop switch. A plurality of finger actuatable paddles may be selectively installed on and removed from a socket on the controller to provide game play inputs. Overlays may be releasably installed by the user on the console to change appearance and/or tactile features of portions of the controller.

### TECHNICAL FIELD

Exemplary arrangements relate to video game controllers that are operative to receive user inputs in conjunction with video gaming activity. Exemplary arrangements further relate to video game controllers that can be modified by the user to receive different types of user inputs and to have a user changeable external appearance.

### BACKGROUND

Video game controllers often have numerous different types of user actuatable input devices. These input devices may be manually actuated by the user during the course of video game play to provide different types of inputs that enable the user to control aspects of the game.

Different types of games may be more effectively or more enjoyably played by a user using input devices with properties that are different than those that are available on the user's video game controller. However game controllers typically do not readily enable the user to change the properties of the input devices or to change the input devices that are available to the user when playing different games. Further the appearance and tactile properties of a video game controller generally are not readily changed by the user on a temporary basis to correspond to a user's current requirements.

Existing video game controllers may benefit from improvements.

### SUMMARY

Exemplary arrangements relate to an apparatus including a video game controller that is configured to receive user inputs in conjunction with video gaming activity. The exemplary controller includes a body with a pair of finger movable triggers thereon. The triggers are disposed from one another on the body and are each movably mounted relative to the body. Each of the exemplary triggers is constrained to move in a trigger range of movement responsive to finger contact with the trigger between an outward position toward which the trigger may be biased, and a fully inward position.

A respective position sensor that is housed within the body is in operative connection with each respective trigger. The position sensor is operative to provide at least one signal indicative of each current position of the respective trigger within the trigger's range of movement. The position sensor is operative to provide to circuitry within the body, signals that indicate the position of each of the triggers so that the functions in the game that are controlled by the positioning of the triggers by the user can be adjusted or otherwise carried out in accordance with the user's trigger inputs.

The exemplary body further includes a pair of trigger stop switches that are housed within the body. Each respective trigger stop switch is associated with a respective trigger. Each trigger stop switch includes an actuator that is movable between a first actuator position and a second actuator position. Each trigger stop switch is operative to provide at least one signal to the circuitry that is indicative of whether the actuator of the stop switch is in the first actuator position or the second actuator position.

The exemplary controller body further includes a pair of links. Each link is movably mounted within the body between a first link position and a second link position. Each link is associated with a respective trigger and a respective trigger stop switch. When a link is in the first link position the link does not cause operative engagement of its associated trigger and the actuator of its associated trigger stop switch when the trigger is moved within its range of movement. However when the link is in the second link position, the link causes the respective trigger and the respective actuator of the trigger stop switch to be operatively engaged. As a result when a respective trigger is moved from its outward position to a stop position which corresponds to only a portion of the trigger range of movement, the respective trigger is prevented from moving further toward the inward position and the trigger is operative to cause the actuator of the stop switch to be moved from the first actuator position to the second actuator position.

The exemplary body further includes a pair of input devices. Each respective input device is associated with a respective trigger. Each of the input devices is manually accessible from outside the body and is manually movable between a first input device position and a second input device position. Each respective input device is in operative engagement with a respective link.

As a result when an input device is in the first input device position, the respective link associated with the input device is caused to be in the first link position. When an input device is in the second input device position, the respective link associated with the input device is caused to be in the second link position. As a result moving the input devices from the first input device positions to the second input device positions causes the triggers to change from input devices that provide signals which vary with the position of the trigger throughout the entire trigger range of movement, to input devices that are movable a much shorter distance from the respective outward position to a stop position at which at least one signal is provided from the trigger stop switch. Thus the triggers are changeable by the user for use in game play situations where rapid actuation of the triggers to produce output signals from the trigger stop switches is desired. Further in exemplary arrangements each of the triggers is operative to receive a perceivable tactile click as the trigger reaches its respective stop position.

In the exemplary arrangements the input devices may be readily manually moved by a user without having to access the interior of the controller body, to change the properties of the triggers. As a result the game controller is readily changed to having the desired properties for different types of game scenarios.

Further exemplary arrangements include the capability to install one or more finger actuatable paddles in operative connection with the body. The paddles are movable through engagement with the user's fingers to provide signals to associated game console circuitry from paddle switches associated with the respective paddles. The exemplary paddles each include a base portion, a finger actuatable pad portion that is disposed away from the base portion, and an arm portion that extends intermediate of the base portion and the pad portion. The exemplary arm portion includes a switch actuating projection thereon.

The controller body includes a socket. The base portions of the respective paddles are engageable with the socket. A releasable socket cover is operative to engage the socket. When the cover is engaged with the socket the base portions of the paddles are held in intermediate relation of the socket and the socket cover, and the respective pad portions and arm portions of the paddles are disposed away from the socket and in overlying relation of the body.

Movement of a respective pad portion of a paddle through finger engagement toward the body, is operative to cause the switch actuating projection of a paddle to engage a paddle switch actuator of a respective paddle switch which changes the condition of the paddle switch. Signals corresponding to the change in the paddle switch condition are received by the circuitry of the game control console and used by the circuitry to provide user control of different aspects of the game.

In some exemplary arrangements a plurality of paddles may be positioned in operative connection with the body of the game controller and held in engagement therewith by the socket and the removable socket cover. Disengagement of the socket cover from the socket enables disengaging each of the paddles from the socket. This facilitates changing the number and position of the paddles as may be desired by the user. Further the exemplary removable socket cover enables readily replacing a paddle which may be broken during game play. Further the circuitry in exemplary arrangements is adapted to enable a user to assign the function that is normally associated with a manually actuatable button or other input device on the control console, to a paddle which may be engaged with the console by the user. Numerous different functions and capabilities may be provided in exemplary arrangements.

Further in exemplary arrangements may provide a user with the ability to change the appearance and tactile surface properties of the body of the game controller in ways that may be desired by the user. In exemplary arrangements at least one overlay may be applied to releasably overlie a portion of the body to change the external body appearance and/or to provide desired external surface properties. In exemplary arrangements the body may include a plurality of disposed body magnets and the overlay may include a plurality of disposed overlay magnets that are each configured to be positioned adjacent to a respective body magnet when the body overlay is installed. Further exemplary arrangements may include a touch panel overlay that is configured to releasably overlie a touch panel of the body.

Additional features and relationships of exemplary arrangements are discussed in the following Detailed Description and shown in the drawings that are submitted herewith.

### BRIEF DESCRIPTION OF DRAWINGS

FIG. 1 is a top plan view of an exemplary video game controller.

FIG. 2 is a right side view of the video game controller.

FIG. 3 is a left side view of an exemplary trigger of a video game controller in the outward position.

FIG. 4 is a view similar to FIG. 3 but with the trigger in a fully inward position.

FIG. 5 is a schematic view of an exemplary trigger position sensor and associated game control console circuitry, with the trigger in the outward position.

FIG. 6 is a schematic view similar to FIG. 5 but with the trigger in the fully inward position.

FIG. 7 is a left side view of an exemplary trigger and trigger stop switch.

FIG. 8 is a view similar to FIG. 7 showing the trigger stop switch and associated link and input device.

FIG. 9 is a view similar to FIG. 8 showing the trigger stop switch, associated link and input device.

FIG. 10 is an interior view of the exemplary controller showing a trigger stop switch arrangement similar to FIG. 9.

FIG. 11 is an enlarged view of the circled area in FIG. 10.

FIG. 12 is a view similar to FIG. 10 with the link member in the first link position.

FIG. 13 is an enlarged view of the circled area in FIG. 12.

FIG. 14 is a bottom view of the exemplary game controller corresponding to the first input device position of the input device in FIGS. 12 and 13.

FIG. 15 is an enlarged view of the circled area in FIG. 14.

FIG. 16 is a view similar to FIG. 14 but with the input device moved to the second input device position.

FIG. 17 is enlarged view of the circled area in FIG. 16.

FIG. 18 is an internal rear view of the exemplary trigger, link, trigger stop switch and the input device in the second input device position.

FIG. 19 is a front view corresponding to FIG. 18.

FIG. 20 is an internal view corresponding to FIG. 18 but with the link in the first link position and the input device in the first input device position.

FIG. 21 is an exploded view of the exemplary link, input device and trigger stop switch as shown in FIG. 20.

FIG. 22 is an internal view of the controller including a trigger and an alternative link and input device.

FIG. 23 is an enlarged view of the circled portion in FIG. 22 showing the link in the second link position.

FIG. 24 is a view similar to FIG. 22 but with the link in the first link position.

FIG. 25 is an enlarged view of the circled area in FIG. 24.

FIG. 26 is a bottom view of the game console of FIG. 23 with the input device in the second input device position.

FIG. 27 is an enlarged view of the circled area in FIG. 26.

FIG. 28 is a view similar to FIG. 26 but with the input device in the first input device position.

FIG. 29 is an enlarged view of the circled area in FIG. 28.

FIG. 30 is an inside view of the trigger, the link in the second link position, and the trigger stop switch.

FIG. 31 is a front view showing the components of FIG. 30 and the input device in the second input device position.

FIG. 32 is a view similar to FIG. 30 but with the link in the first link position and the input device in the first input device position.

FIG. 33 is an exploded view of the exemplary input device, link and trigger stop switch shown in FIG. 32.

FIG. 34 is an inside view of the exemplary controller showing the stem of the input device.

FIG. 35 is an enlarged view of the circled area in FIG. 34.

FIG. 36 is a bottom view of the exemplary input device.

FIG. 37 is a bottom internal view of the control console showing an exemplary trigger and link.

FIG. 38 is a transverse cross-sectional view of the exemplary link, input device and a portion of the body of the controller taken along line 38-38 in FIG. 37.

FIG. 39 is a bottom internal view of the controller showing an exemplary slot arrangement for guiding movement of the input device.

FIG. 40 is enlarged view of the circled area in FIG. 39.

FIG. 41 is a schematic view of an exemplary trigger and a trigger stop switch which is actuated by an alternative link.

FIG. 42 is a bottom internal view of an exemplary controller including a trigger, an alternative link and trigger stop switch, and an alternative input device with the link in the second link position.

FIG. 43 is an enlarged view of the circled area in FIG. 42.

FIG. 44 is a view similar to FIG. 42 but with the link in the first link position.

FIG. 45 is enlarged view of the circled area in FIG. 44.

FIG. 46 is a bottom view of the exemplary game controller and the alternative input device.

FIG. 47 is an enlarged view of the circled area in FIG. 46.

FIG. 48 is a rear view of the exemplary trigger, the link in the second link position, the input device and the trigger stop switch.

FIG. 49 is a front view corresponding to FIG. 48.

FIG. 50 is a view corresponding to FIG. 48 but with the link in the first link position and the input device in the first input device position.

FIG. 51 is an exploded view of the components shown in FIG. 48.

FIG. 52 is a bottom internal view of the exemplary game controller and the link, input device and trigger stop switch.

FIG. 53 is an enlarged view of the circled portion in FIG. 52.

FIG. 54 is a front view of an exemplary input device.

FIG. 55 is a cross-sectional view of the input device taken along lines 55-55 in

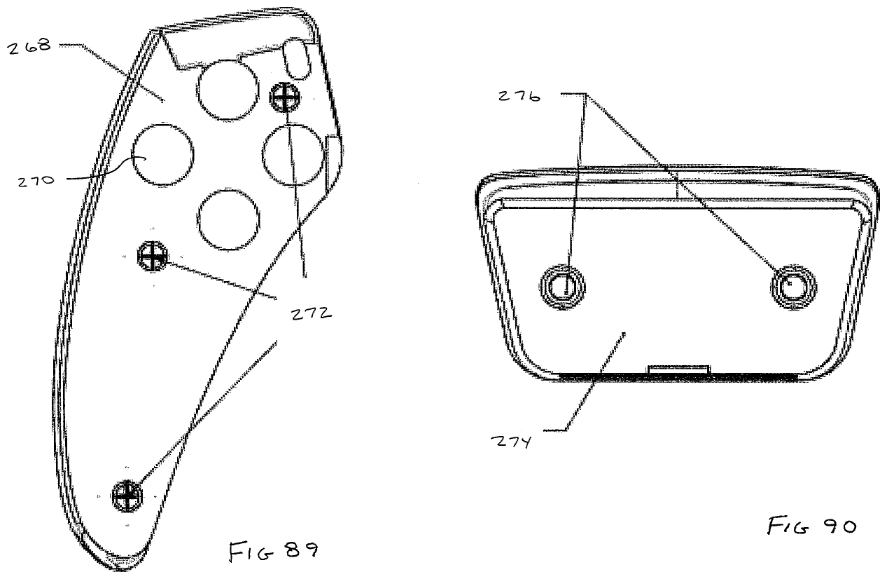

FIG. 54.

FIG. 56 is a bottom view of the exemplary control console with the link in the second link position, the input device in the second input device position and the exemplary trigger stop switch.

FIG. 57 is a cross-sectional view taken along line 57-57 in FIG. 56.

FIG. 58 is an enlarged view of the circled area in FIG. 57.

FIG. 59 is a bottom internal view of an exemplary controller with an alternative link, input device and trigger stop switch arrangement, with the link in the second link position.

FIG. 60 is enlarged view of the circled area in FIG. 59.

FIG. 61 is a view similar to FIG. 59 but with the link in the first link position and the input device in the first input device position.

FIG. 62 is an enlarged view of the circled area in FIG. 61.

FIG. 63 is a bottom view of the interior area of the game controller showing the exemplary input device in the second input device position.

FIG. 64 is enlarged view corresponding to the circled area in FIG. 63.

FIG. 65 is a bottom view of the exemplary game controller with the input device in the first input device position.

FIG. 66 is enlarged view of the circled area in FIG. 65.

FIG. 67 is a rear view of the trigger, trigger stop switch and exemplary link in the second link position.

FIG. 68 is a front view corresponding to FIG. 67.

FIG. 69 is a view similar to FIG. 67 but with the link in the first link position.

FIG. 70 is an exploded view of the exemplary link in the second link position.

FIG. 71 is a top view of an exemplary electrical connector for connecting a trigger stop switch to the circuitry of the game console.

FIG. 72 is a bottom view of the electrical connector of FIG. 71.

FIG. 73 is a cutaway front view of an exemplary game controller showing the electrical connector.

FIG. 74 is enlarged view of the circled area in FIG. 73.

FIG. 75 is a further bottom cutaway view of the exemplary game controller showing the exemplary electrical connector.

FIG. 76 is an enlarged view of the circled area in FIG. 75.

FIG. 77 is a cutaway view of an exemplary game controller showing the exemplary electrical connector.

FIG. 78 is an enlarged view of the circled area in FIG. 77.

FIG. 79 is a bottom view of the exemplary game controller with four paddles installed thereon.

FIG. 80 is a bottom perspective view of an exemplary paddle.

FIG. 81 is a top perspective view of an exemplary paddle.

FIG. 82 is a back view of an exemplary paddle.

FIG. 83 is a perspective view of the exemplary socket in which the paddles are releasably engaged.

FIG. 84 is an enlarged view of the exemplary socket.

FIG. 85 is a view of an exemplary circuit board of the game controller including circuitry showing exemplary paddle switches and paddle switch actuators.

FIG. 86 is a side cross-sectional view showing an exemplary paddle and paddle switch.

FIG. 87 is a plan view of an exemplary flexible electrical connector utilized for connecting the circuit board associated with the paddles and other circuitry of the game controller.

FIG. 88 is a top perspective view of a portion of the exemplary game controller.

FIG. 89 is a top view of an exemplary overlay which may be releasably installed in overlying relation of a portion of the game controller.

FIG. 90 is a top view of an exemplary overlay which may be installed in overlying relation of a touch panel of the exemplary game controller.

### DETAILED DESCRIPTION

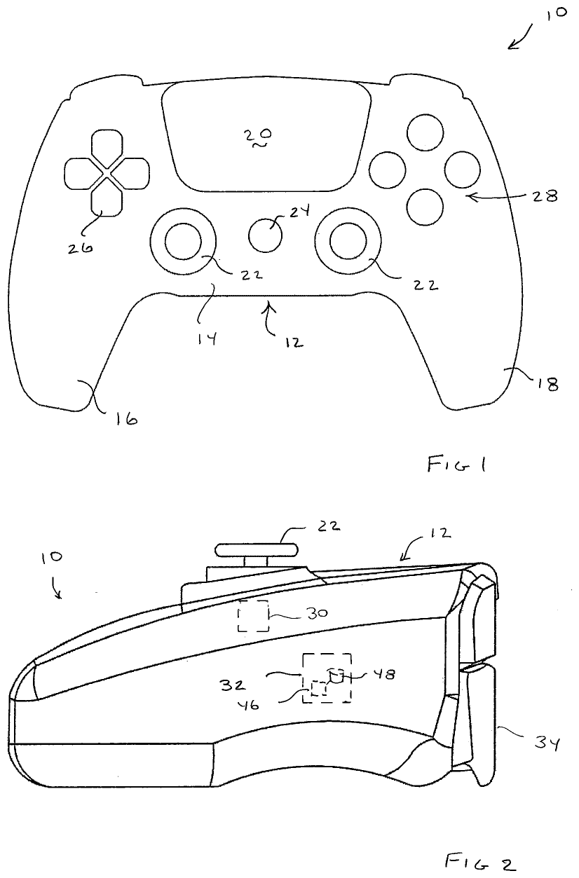

Referring now to the drawings and particularly to FIG. 1 there is shown therein an exemplary video game controller 10. The exemplary controller includes a body 12. The body 12 includes a central portion 14 and a pair of arm portions 16, 18. The exemplary central portion 14 includes a touch panel 20 on an upper side thereof. The exemplary touch panel comprises a touchscreen display that is operative to provide visual outputs and receive touch contact inputs. The exemplary central portion further includes input devices including a pair of control sticks 22 each configured to receive inputs responsive to user finger contact therewith. The central portion further includes a central user input button 24.

The exemplary arm portion 16 includes input devices including a plurality of associated user input buttons 26. In exemplary arrangements the buttons 26 may be utilized for providing directional or other types of user selection inputs responsive to a respective button being pressed. Arm portion 18 includes input devices including a plurality of user input buttons 28. Exemplary buttons 28 may be further utilized by the user to provide user inputs to the controller. As can be appreciated each of the exemplary input devices 22, 24, 26 and 28 have associated therewith a respective device for producing electrical signals responsive to user actuation of the input device that is alternatively referred to herein as a switch, one of which is schematically represented 30, which switch provides electrical signals responsive to user actuation of the input device with which the switch is associated. Each of the switches is in operative connection with circuitry 32 of the game controller.

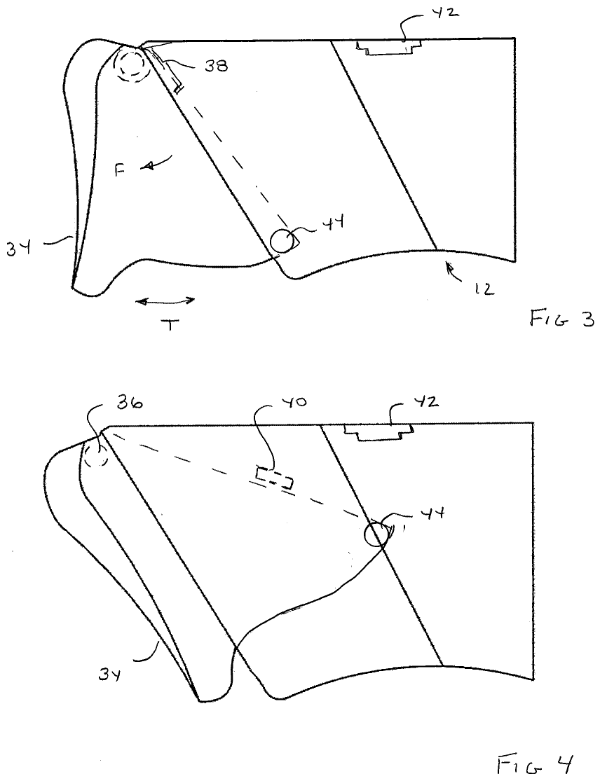

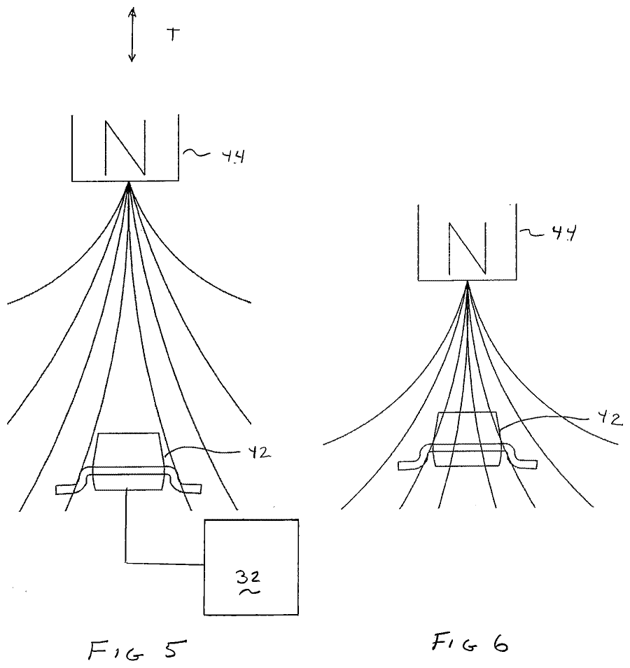

At the front of each respective arm portion an exemplary trigger 34 is positioned. Each exemplary trigger is movably mounted in operative connection with the body 12. Each exemplary trigger 34 is rotatable about a respective pivot 36 such as is shown in schematically in FIGS. 3 and 4. Each exemplary trigger 34 is biased toward an outward position such as is shown in FIG. 3. In exemplary arrangements each trigger may be biased by a respective spring such as torsion spring 38 which provides a biasing force in a direction represented by Arrow F.

Each exemplary trigger is constrained to move along a trigger direction T between the outward position such as is shown in FIG. 3, and a fully inward position as represented in FIG. 4. In the fully inward position the trigger may be engageable with a limit block 40 or other motion limiting structure. In exemplary arrangements each trigger is associated with at least one respective position sensor 42. In the exemplary arrangement the position sensor 42 is housed within the body and is operative to produce at least one signal that is indicative of each current position of the trigger within the trigger range of movement between the outward position and the fully inward position.

In some exemplary arrangements the position sensor 42 may comprise a Hall Effect sensor. In exemplary arrangements the position sensor 42 is enabled to provide signals indicative of the current position of the trigger within the trigger range of movement by detecting a level of magnetic flux to which the sensor is currently exposed as a result of the current position of the trigger.

As schematically represented in FIGS. 5 and 6, in some exemplary arrangements the trigger 34 has in operatively engaged relation therewith at least one magnetic element (n) schematically indicated 44. As the magnetic element changes its position relative to the position sensor responsive to the current position of the trigger 34 within its range of movement, the position sensor detects an amount of magnetic flux which is indicative of the position of the magnetic element 44 and the current position trigger 34 within its range of movement. The exemplary position sensor 42 is operative to transmit signals to the controller circuitry 35 which are usable by the circuitry to determine the position of the respective trigger. As a result the circuitry is able to determine the current position of each trigger and utilize the position of the trigger as positioned by the user, to control aspects of the particular user game play. It should be understood however that while the exemplary position sensor arrangement disclosed herein is useful, it is exemplary and in other arrangements other position sensors may be used to determine the current position of each trigger.

The exemplary video game controller 10 may include numerous different features and elements which facilitate the playing of games by user. Exemplary features which may be included in exemplary controllers are described in US Patent Publications 20180250587 A1; 20190329127 A1; 20160351362 A1; 20200016484 A1; 20160346682 A1; 20120142418 A1; 20170361221 A1 and/or in U.S. Pat. No. 9,492,742 B2, the disclosures of which US Patent Publications and US patent are each incorporated herein by reference in their entirety. For purposes of this disclosure a video game controller includes a device that operates video game software within the device and provides signals which can be used to provide visual outputs from a display or other output device, referred to as a game console, as well as a device that is operated by a user to provide user inputs to a game console or other device which operates video game software.

In exemplary arrangements the circuitry includes one or more circuits that are operative to communicate electrical signals with the input devices such as the buttons, triggers, touchscreen display and other components of the controller and to control the operation of output devices such as the touch display and other devices which comprise the controller. In exemplary arrangements the at least one circuit includes at least one processor schematically indicated 46 and at least one data store schematically indicated 48. In exemplary arrangements the processor may include a processor suitable for operating software by carrying out circuit executable instructions that are stored in the one or more associated data stores. In exemplary arrangements the processor includes or is in operative connection with a nonvolatile storage medium including instructions that include a basic input/output system. For example the exemplary processors may correspond to one or more of a combination of a CPU, FPGA, ASIC or other integrated circuit or type of circuit that is capable of processing data and executing instructions. Exemplary data stores may correspond to one or more of volatile or nonvolatile memories such as random access memory, flash memory, magnetic memory, optical memory, solid-state memory or other devices that are operative to store circuit executable instructions and data. Circuit executable instructions may include instructions in any of a plurality of programming languages and formats including, without limitation, routines, subroutines, programs, threads of execution, scripts, objects, methodologies and functions which may be used to carry out the actions such as those described herein and in the incorporated disclosures. Structures for exemplary processors and data stores may include, correspond to and utilize the principles described in the textbook entitled Microprocessor Architecture, Programming and Applications with the 8085 by Ramesh S. Gaonker, Sixth Edition, (Penram International Publishing 2013) which is incorporated herein by reference in its entirety.

The exemplary video game controller includes features that enable a user to change properties of at least one of the triggers, control sticks, buttons and other input devices to facilitate certain types of game play. In exemplary arrangements the exemplary triggers can be selectively configured by the user to be operated in two different operational modes. In exemplary arrangements the user may operate one or both triggers in a mode in which a trigger is operative to provide at least one signal indicative of each position within the constrained trigger range of movement such that the user can provide inputs which control the game play in ways that correspond to all the different positions of the trigger in the full range of movement between the outward position and the fully inward position. Alternatively the user may operate one or both triggers in a second operational mode in which a trigger may be limited to movement from the outward position along the trigger movement direction to only a stop position, which stop position corresponds to only a relatively small portion of the total trigger range of movement toward the fully inward position. In exemplary arrangements in the stop position the trigger is prevented from moving further along the trigger movement direction toward the fully inward position. Further in the stop position the trigger is operative to cause an actuator on a trigger stop switch to move between a first actuator position and a second actuator position. In exemplary arrangements movement of the actuator of the trigger stop switch is operative to cause the trigger stop switch to provide at least one signal indicative of whether the actuator is in the first actuator position or the second actuator position. In some arrangements the signal that is received from the actuator or the trigger stop switch in the second actuator position may correspond to a signal that would be received from a trigger position sensor when the trigger has been moved to the fully inward position.

In exemplary arrangements the ability of the user to readily configure each of the triggers to be changed from the mode in which the position sensor enables providing signals indicative of the trigger position throughout the full trigger range of movement, to a configuration in which the trigger is moved only a smaller relative amount from the outward position to stop position in which the trigger stop switch provides signals indicative of actuator movement, facilitates certain types of game play in which the user is able to provide inputs to control the game through more rapid trigger actuation movements. Further in exemplary arrangements the trigger receives a tactile click responsive to movement of the trigger changing the actuator position of the trigger stop switch which is receivable by the user.

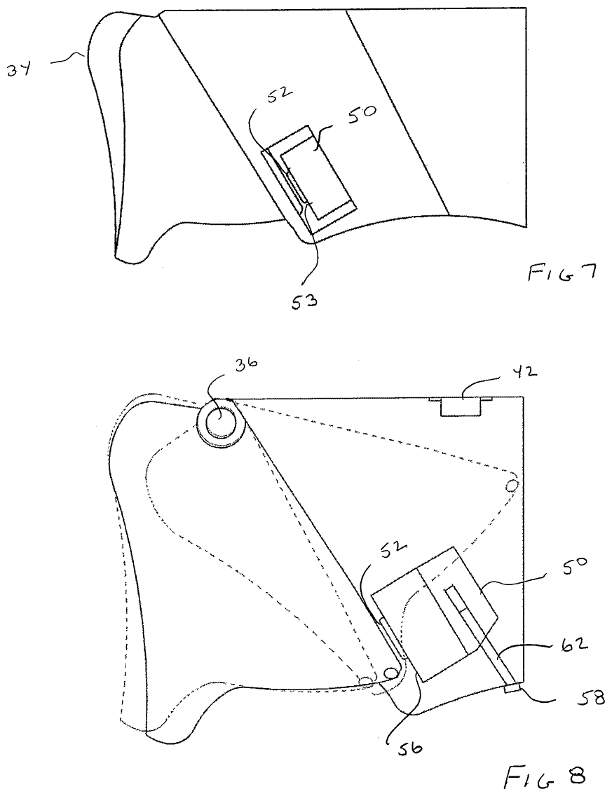

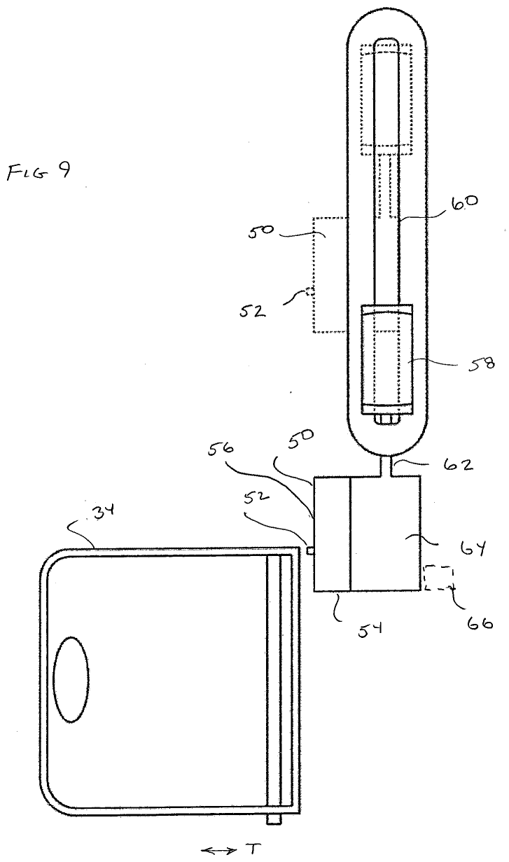

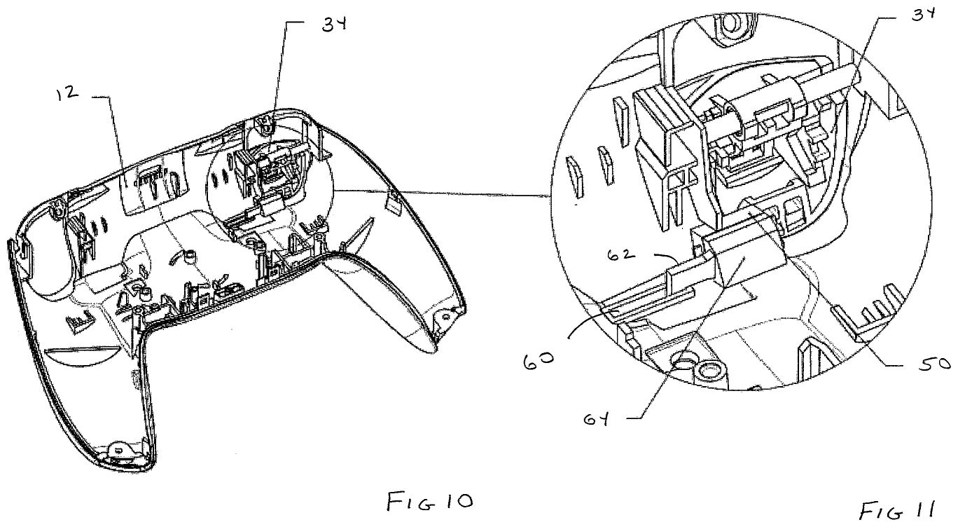

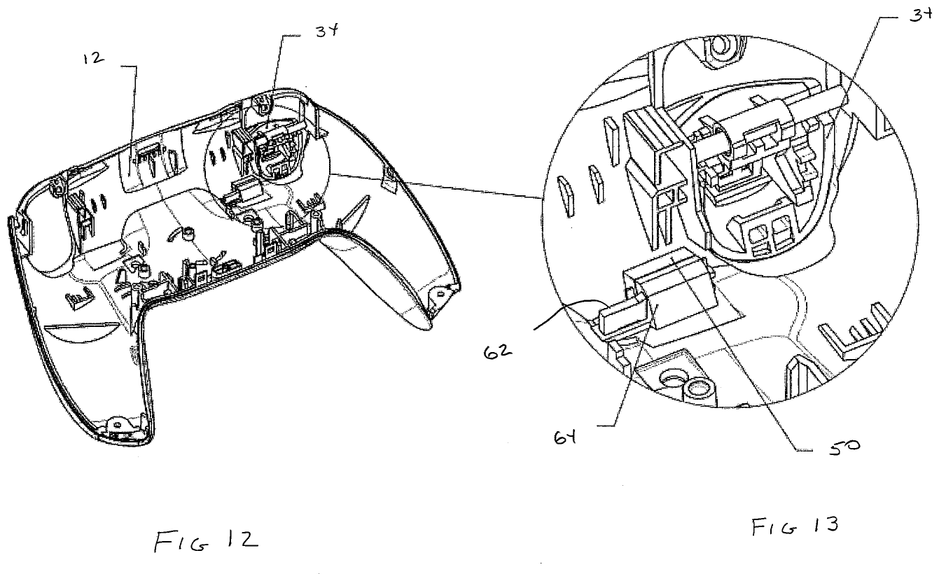

As shown in FIGS. 7-21, an exemplary arrangement in which a trigger stop switch that is selectively actuatable responsive to movement of a trigger along the trigger movement direction from an outward position to a stop position, which stop position corresponds to trigger movement along the trigger range of movement that is much less than the trigger movement from an outward position to a fully inward position. In this exemplary arrangement a game control console is enabled to be readily configured by the user to selectively enable a trigger 34 to function in a manner in which signals from a position sensor 42 indicate each position of the trigger between the outward position and the fully inward position shown in phantom in FIG. 8, or to function in a manner where trigger movement from the outward position is limited to a stop position (shown in solid lines in FIG. 8) in which the trigger causes a trigger stop switch 50 to provide at least one signal that is indicative of the position of an actuator 52 of the trigger stop switch.

In this exemplary arrangement the trigger stop switch 50 includes a body 54 which includes an opening 53 therein. The actuator 52 is movable in the opening 53 between a first actuator position in which the actuator extends further outward from the opening and the surrounding body surface 56 than is a second actuator position. In exemplary arrangements the actuator 52 is biased outwardly from the body to the first actuator position. Movement of the actuator 52 inwardly in the opening into the body causes the actuator to move to a second actuator position. When the actuator 52 reaches the second actuator position the actuator provides a tactilely perceivable click that in exemplary arrangements can be perceived by the user who has moved the associated trigger 34 into the stop position. The exemplary trigger stop switch 50 is operative to provide signals to the controller circuitry that are indicative of whether the actuator is in the first actuator position or the second actuator position. Such signals are usable by the circuitry to enable user control of the game play.

In the exemplary arrangement the controller includes an input device 58 that is user accessible on the outside surface of the controller body. The exemplary input device is movable between a first input device position (shown in phantom in FIG. 9) and a second input device position shown in solid lines in FIG. 9. In the exemplary arrangement shown, the input device comprises a button that is movable between the first input device position and the second input device position in guided relation with a slide slot 60 that extends through the outer wall of the body.

In the exemplary arrangement a link 62 is movably mounted in the body. The exemplary link is in operative connection with the input device 58 which in this arrangement comprises a slidable button. In the exemplary arrangement the link is movable between a first link position and a second link position. The first link position is shown along with the positions of the input device and trigger stop switch 50 shown in phantom in FIG. 9. As shown in FIG. 9 in the first link position the trigger stop switch 50 and the actuator 52 are transversely disposed away from the trigger 34 such that during movement of the trigger throughout its full range of movement there is no operative engagement between the trigger 34 and the actuator 52 of the trigger stop switch 50.

As shown in solid lines in FIG. 9 when the input device 58 is moved to the second input device position the link is caused to be moved to the second link position. In the second link position the link causes the trigger and the actuator of the trigger stop switch to be operatively engaged such that when the trigger is moved from its outward position to the stop position, the trigger operates to cause the actuator 52 to be moved from the first actuator position in which the actuator extends outward from the trigger body to the second actuator position in which the actuator is pressed into the trigger body. In exemplary arrangements the trigger stop position corresponds to only a portion of the trigger range of movement from the outward position to the fully inward position. In the exemplary arrangement shown in FIG. 9 the link 62 includes a base portion 64 to which the trigger stop switch is operatively attached. In the second link position the base portion may be in immediately adjacent relation with an abutment structure 66 of the body. As a result in this exemplary arrangement the trigger 34 is prevented from moving beyond the stop position toward the fully inward position as a result the solid engagement of the trigger stop switch 52, the base portion 64 and the abutment structure 66. Of course it should be understood that while this approach while useful, it is exemplary and in other arrangements other approaches may be used.

FIGS. 10 and 11 show a rear view within the body of the controller of the trigger stop switch and link 62 in the second link position. As represented in FIG. 11 an inner face of the trigger 34 is configured to engage and move the actuator from the first actuator position to the second actuator position in response to movement of the trigger from the outward position to the stop position. As previously discussed, the exemplary trigger stop switch is operative to cause the trigger to receive a tactilely perceivable click as the trigger moves the actuator to the second actuator position.

FIGS. 12 and 13 are views similar to FIGS. 10 and 11 except that the link 62 is shown moved to the first link position. As is shown in FIG. 13 with the link in the first link position, the trigger 34 is enabled to move throughout its full range of movement from the outward position to the fully inward position, and the position sensor 42 to detect the position of the trigger in each position between the extremes of movement.

FIGS. 14 and 15 show the bottom of the exemplary controller. In these Figures the input device 58 is in the first input device position which in this arrangement is in an inward position in the slide slot 60. In this position the link is operative to cause the trigger stop switch 60 to be in a position corresponding to that shown in FIG. 13 in which movement the trigger does not cause the trigger to change the position of the actuator of the trigger stop switch.

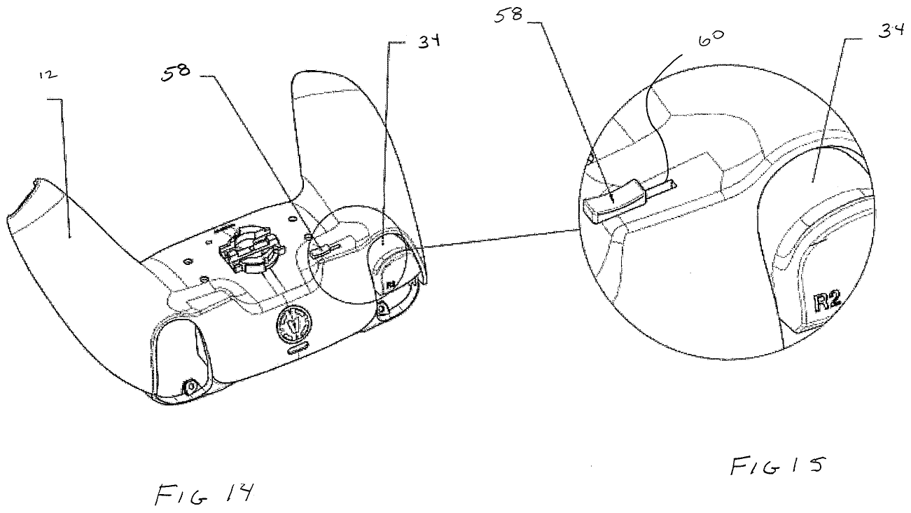

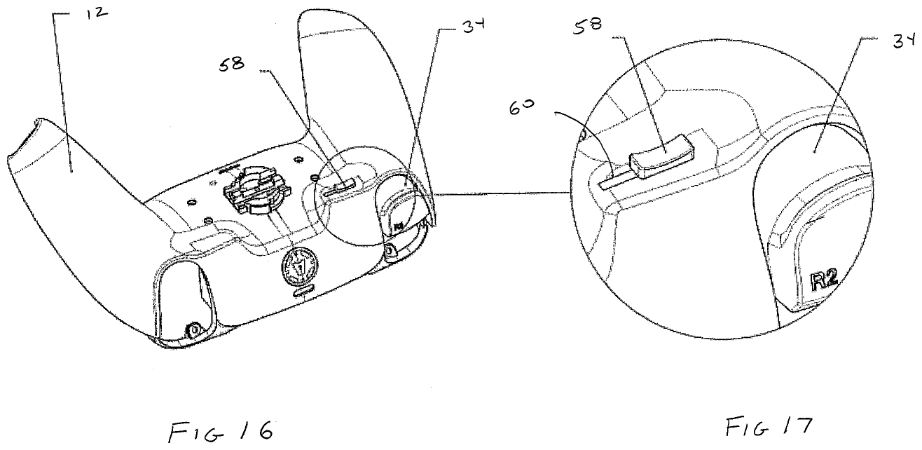

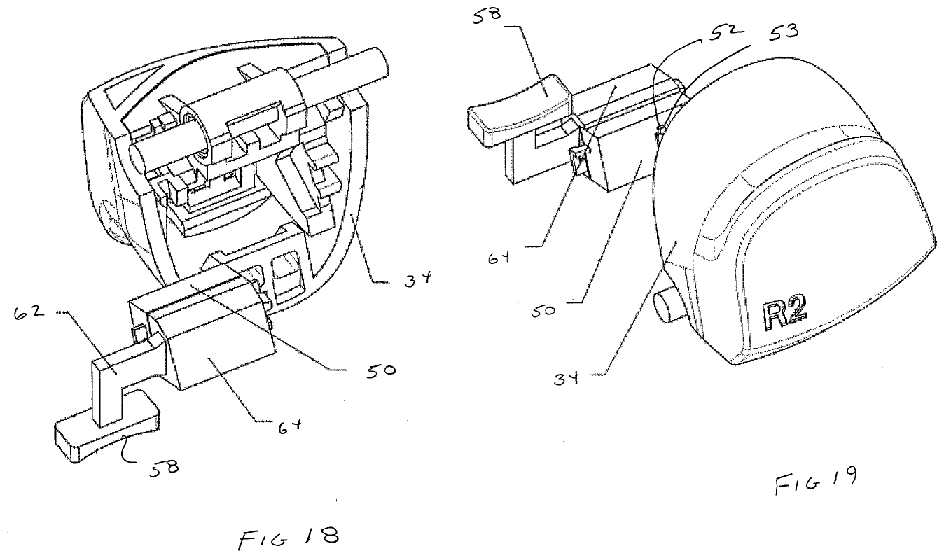

FIGS. 16 and 17 show the bottom of the controller body with the input device 58 in the second input device position. With the input device in the position shown in FIG. 17, the trigger stop switch 60 is positioned in a manner corresponding to that shown in FIG. 11. As a result the movement of the trigger is limited to the stop position which enables the user to very quickly manipulate the trigger to change the configuration of the actuator of the trigger stop switch and for the circuitry to receive signals that result from the change in the condition of the trigger stop switch.

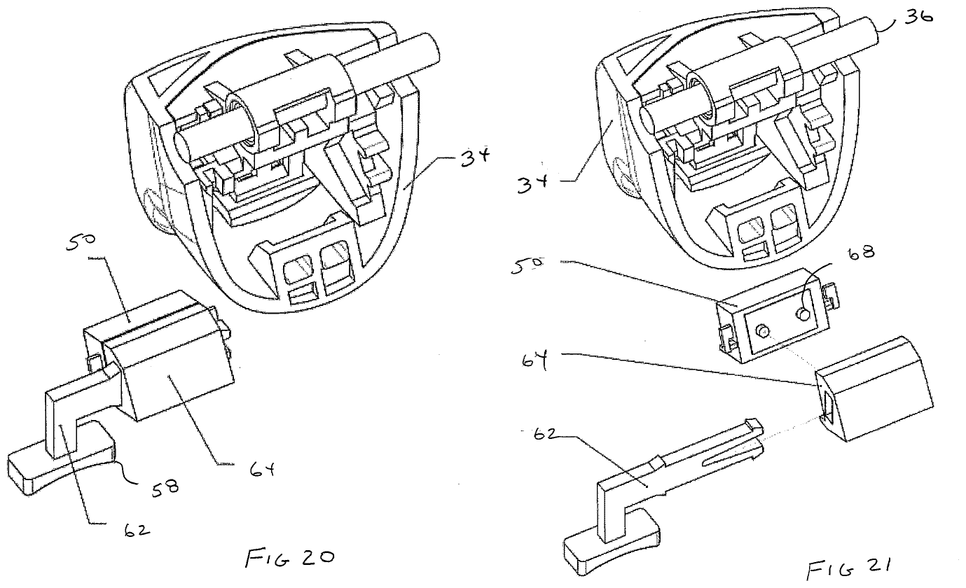

As shown in FIGS. 20 and 21 in some exemplary arrangements the input device 58 which comprises a slidable button may be integrally formed with the link 62. Further in some exemplary arrangements the base portion 64 of the link may be releasably engageable with the link. This feature may be useful in some exemplary arrangements in which different configurations of base portions may be needed to cause movement of the trigger to be further prevented in the stop position by engaging abutment structures within the body of the controller.

In other arrangements different structures may be utilized for purposes of engaging the trigger stop switch 50 with the link 62. For example in some exemplary arrangements the side of the trigger stop switch opposed of the actuator 52 may include positioning projections 68. The positioning projections may be engaged in positioning recesses that help to assure the precise positioning of the trigger stop switch and the actuator thereof which helps assure that movement of the trigger is limited to the stop position. In some exemplary arrangements the positioning projections may be used to mount the trigger stop switch on a circuit board along with other circuitry that is utilized in the controller. Of course it should be understood that these features while useful, are exemplary and in other arrangements other features, elements and arrangements may be used.

Further it should be appreciated that in this exemplary configuration each trigger has an associated input device, link and trigger stop switch. As a result the user of the controller is enabled to change the mode of operation of each trigger individually by manually moving the respective input device on the outside of the controller body. In many situations the user will want both of the triggers be simultaneously operating in the same mode of operation. However in some types of game play a user may find it desirable to have one trigger operating in a different mode of operation from the other trigger. Further the exemplary arrangements enable a user to quickly change the mode of operation of each trigger by moving the respective input devices associated with the triggers between the first and second input device positions.

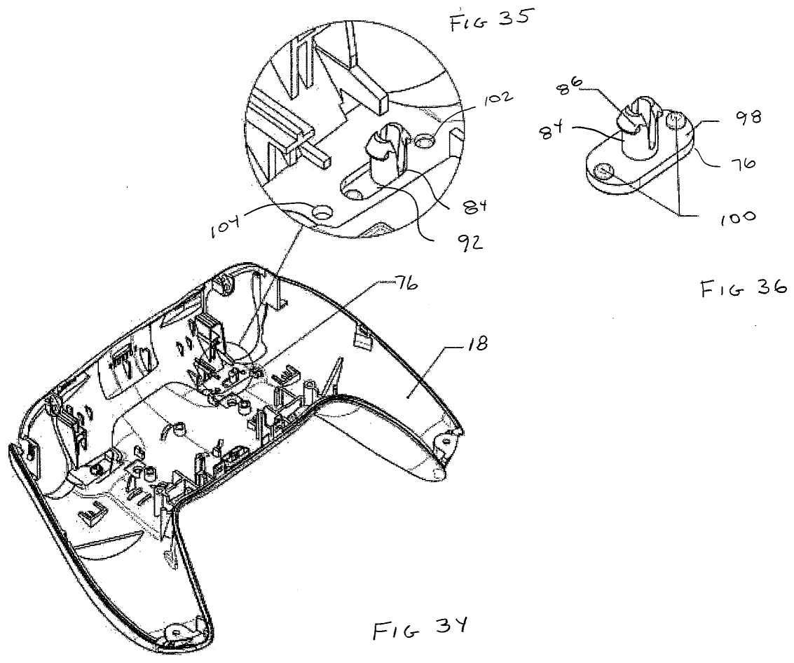

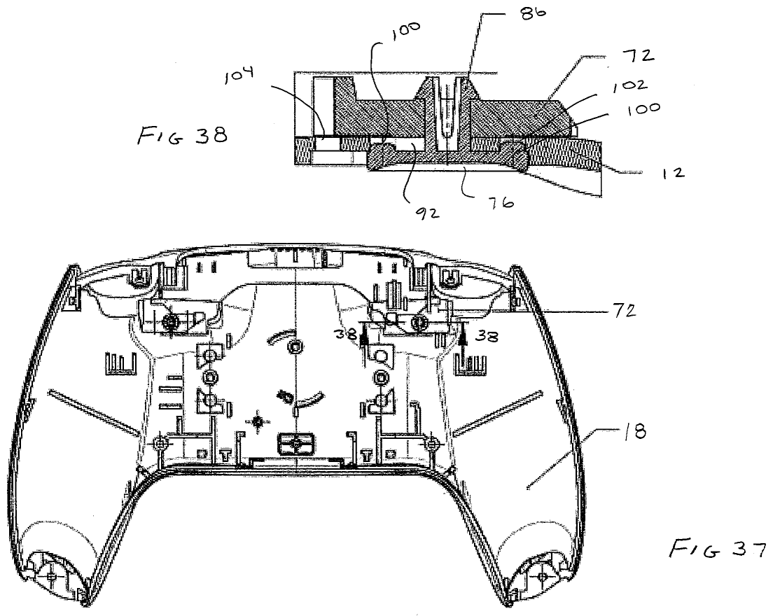

FIGS. 22-40 show a further alternative exemplary arrangement in which the triggers 34 may be selectively operated in a first mode of operation in which the position of each trigger within the entire range of movement may be determined through operation of the controller circuitry, or in a second mode of operation in which each trigger may be operated more rapidly to actuate a trigger stop switch.

FIG. 22 shows the interior area of a controller with two finger actuated triggers 34. This exemplary arrangement includes a position sensor similar to the position sensor 42 previously discussed which is operative to generate signals indicative of a current position of the respective trigger between its outward position and the fully inward position. The exemplary arrangement further includes a trigger stop switch 70 which is actuatable responsive to movement of a rotatable link 72. The exemplary link 72 is rotatable about an axis 74 the location of which axis is selectively changed responsive to movement of an input device 76 which in this exemplary arrangement comprises a slidable button.

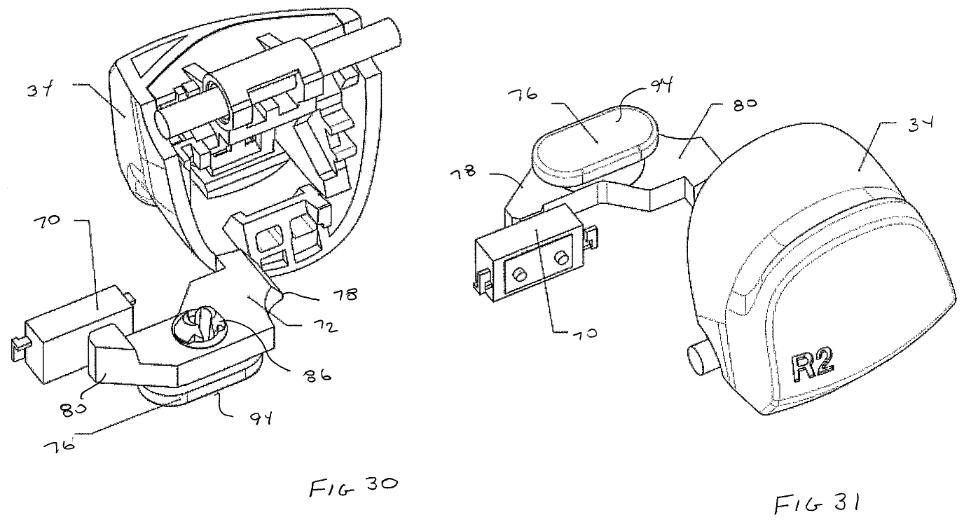

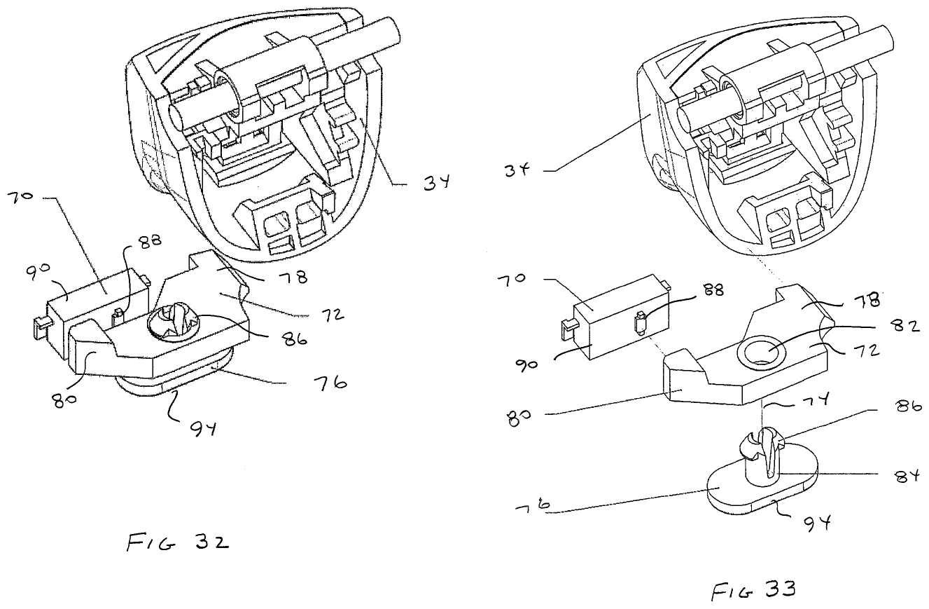

In this exemplary arrangement the link 72 is selectively positionable in a first link position which is shown for example from the rear in FIG. 32. In the first link position a first leg portion 78 of the link 72 is disposed transversely away from an inner face of the trigger 34. As a result movement of the trigger throughout its range of movement between an outward position and the fully inward position does not cause the first leg portion 78 of the leg 72 to be engaged with the trigger.

In this exemplary arrangement the link 72 further includes a second leg portion 80 that is disposed on an opposed side of the axis 74 from the first leg portion. The exemplary link 72 includes a central aperture 82 which is centered relative to the axis. The exemplary input device 76 includes a pivot post 84 that extends from an inner surface thereof. The pivot post 84 terminates in a pair of outward extending engaging projections 86. The pivot post extends axially through the central aperture and is held within the aperture by the engaging projections 86.

Similar to the previously described arrangement, the trigger stop switch 70 includes an actuator 88. The actuator 88 extends through an opening in the body 90 of the trigger stop switch. The actuator 88 is movable between a first actuator position in which the actuator 88 extends outwardly in the opening and to which the actuator is biased, and a second actuator position in which the actuator 88 is pressed inwardly into the switch body. Similar to the previously described arrangement the trigger stop switch 70 is operative to provide at least one signal indicative of whether the actuator is in the first actuator position or the second actuator position.

As shown for example in FIG. 35, the exemplary pivot post 84 extends through an elongated slot 92 in the body of the controller. The slot 92 extends in the direction that is transverse to the direction of trigger movement. When the pivot post 84 extends through the slot 92, the button head 94 of the input device 76 is accessible by the user on the outside of the body. Movement of the input device 76 by the user relative to the slot enables changing the location of the axis 74 about which the link 72 rotates.

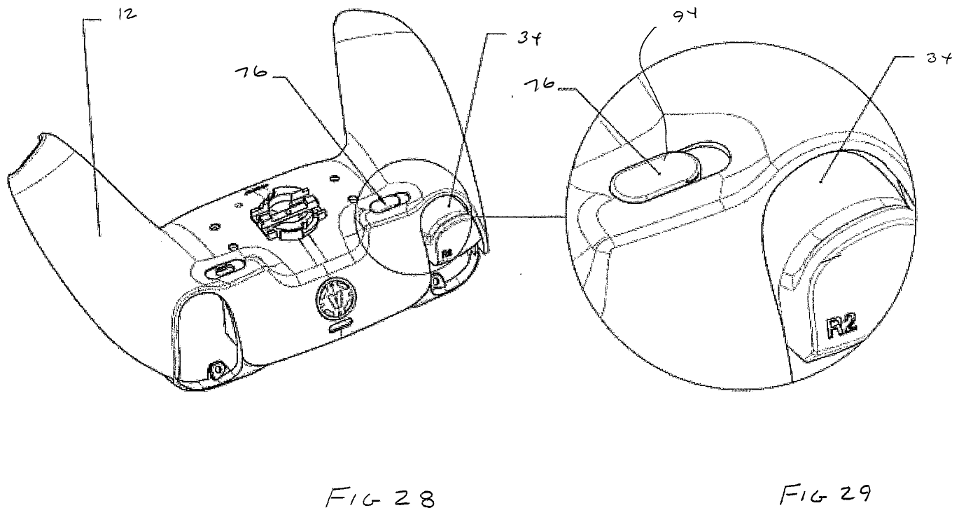

Thus as shown for example in FIGS. 24 and 25 with the link 72 in the first link position such that the first leg portion 78 is disposed away from the inner face of the trigger 74 during movement, the link 72 is not moved responsive to trigger movement. When the link is in the first link position the input device 76 is positioned with the button head 94 thereof positioned relative to the slot as shown in FIGS. 28 and 29.

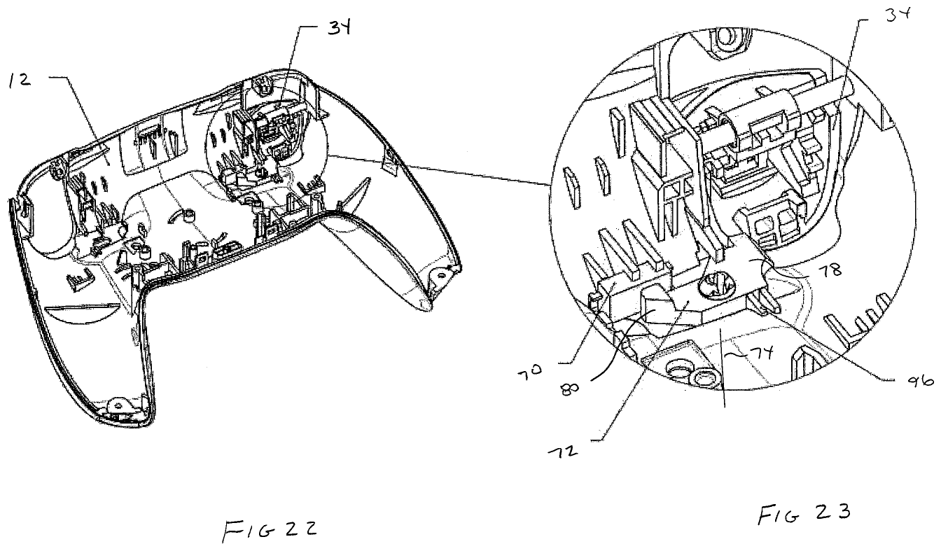

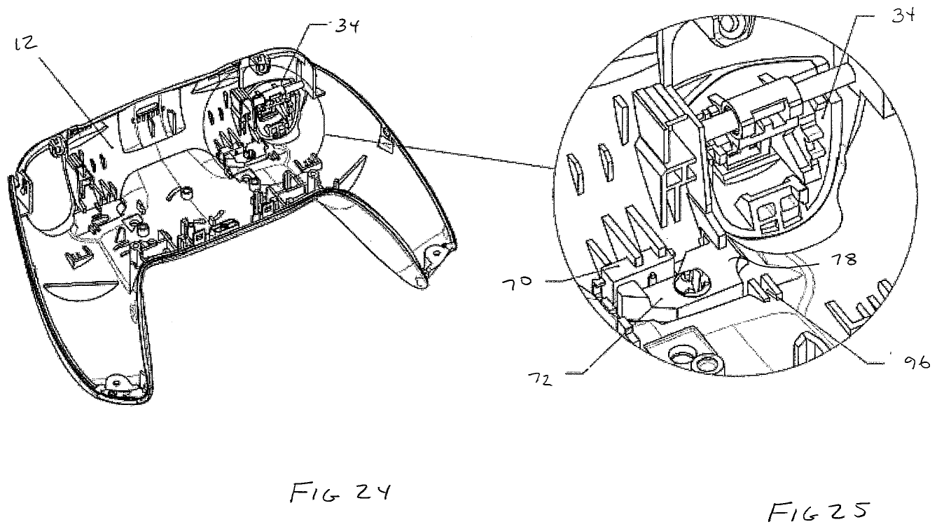

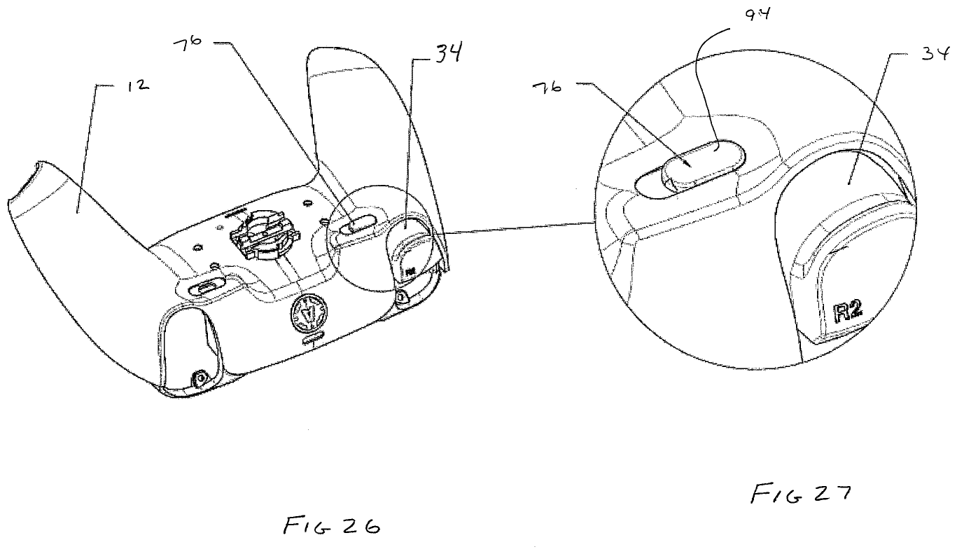

Movement of the input device 76 to the second input device position so that the button head 94 thereof is positioned as shown in FIGS. 26 and 27, causes the link 72 thereof to be positioned as shown in FIGS. 22 and 23. In the second link position the first leg portion 78 of the link is engaged with an inner surface of the trigger when the trigger moves from the outward position to a stop position which is only a small portion of the range of movement of the trigger. Engagement of the trigger with the first leg portion 78 causes rotation of the link, and causes the second leg portion 80 to move the actuator 88 from the first actuator position to the second actuator position in which the actuator is moved inwardly into the body of the stop switch 70.

As with the previously described arrangement, movement of the actuator 88 to the second actuator position is operative to cause a tactile click that is perceivable by the user moving the trigger, and which indicates to the user that the trigger has reached the stop position. Releasing the trigger causes the trigger to return to its outward position responsive to the spring 38 or other biasing means. In exemplary arrangements the body includes reinforcing projections 96. In exemplary arrangements the reinforcing projections 96 are configured to prevent deformation of the link 72 and the input device 76 responsive to high forces that may be applied by the user to the trigger. Of course it should be understood that the reinforcing projections shown while useful, are merely exemplary and in other arrangements other reinforcing elements and structures may be utilized.

In some exemplary arrangements provisions may be made to help to assure that the input device 76 remains in the first input device position or the second input device position as set by the user. FIGS. 34-38 show an exemplary arrangement that facilitates holding the input device 76 in the second input device position. In this exemplary arrangement the input device 76 is modified from the version previously shown such that it includes an inward slot facing surface 98 with a pair of disposed inward extending projections 100. The inward extending projections are generally circular projections that extend outward from the slot facing surface on each side of the pivot post 84.

In this exemplary arrangement the body includes circular recesses 102, 104 outward from opposed ends of the slot 92. As shown in FIG. 38 when the input device 76 is moved to the second input device position, a circular projection 100 is engaged in recess 102. The engagement of the projection and the recess is operative to help to hold the input device in the second input device position and the link 72 in the second link position. As can be appreciated from FIG. 38, when the input device 76 is moved in the slot 92 to the first input device position, an inward extending projection 100 is engaged in recess 104. Such engagement helps to hold the input device in the first input device position. Of course it should be understood that while this arrangement is useful, it is exemplary and in other arrangements other approaches for holding the input device and the link in a desired set position may be used.

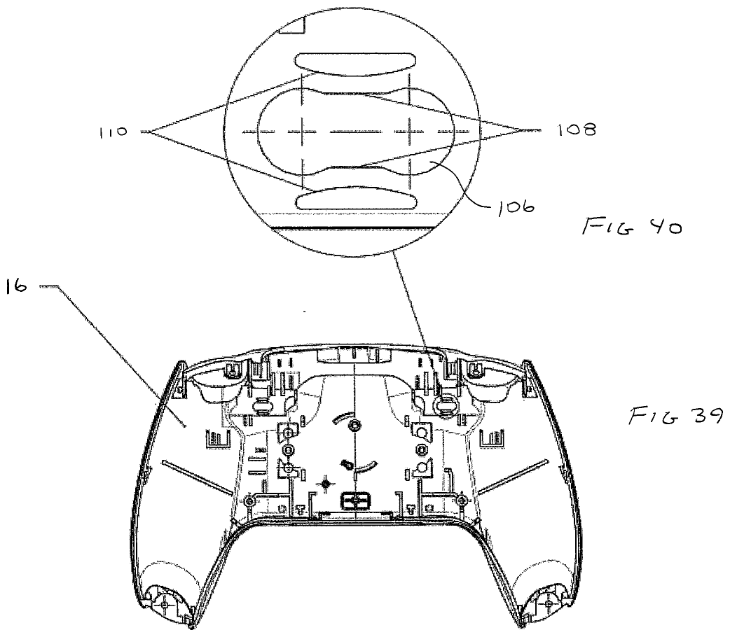

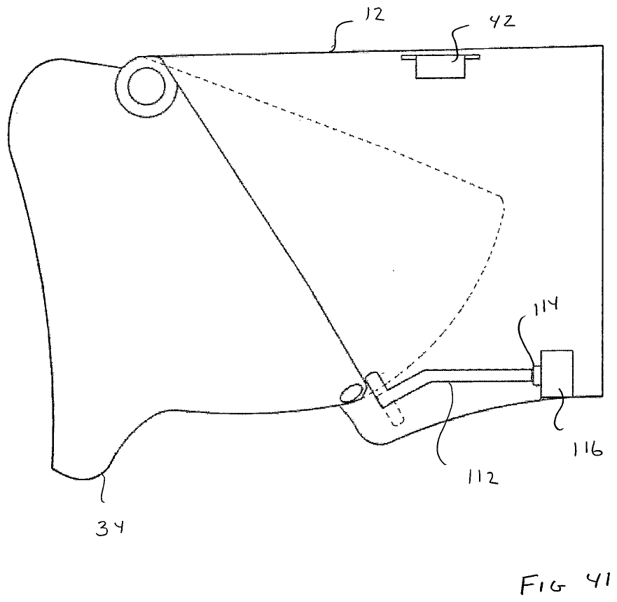

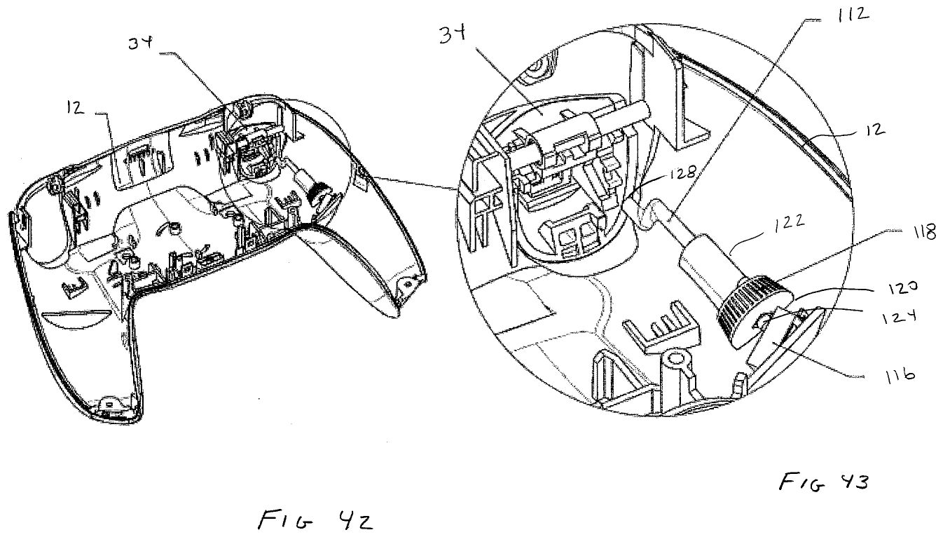

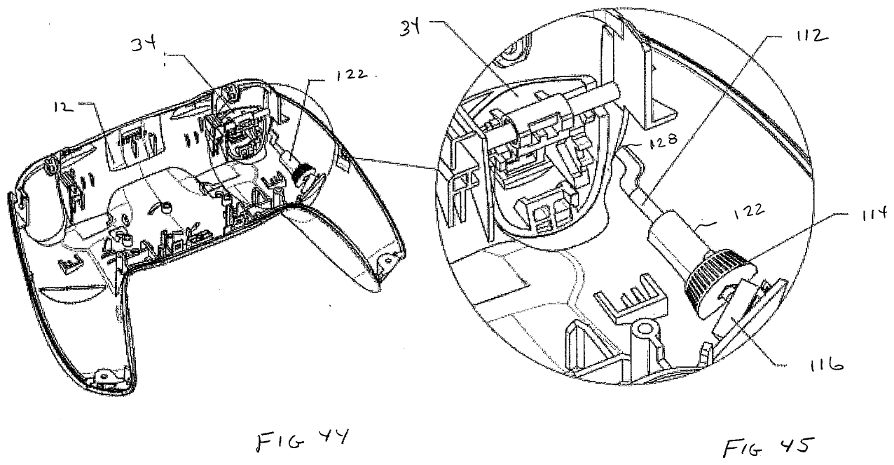

FIGS. 39 and 40 show an alternative exemplary arrangement for holding the input device 76 in a user set position. In this exemplary arrangement a slot 106 in which the pivot post is moved as the input device moves between the first input device position and the second input device position, includes a central constricted area 108. The exemplary constricted area helps to prevent the inadvertent movement of the input device from the user set position. Further in this exemplary arrangement a pair of downward extending protrusions 110 each extend immediately adjacent to the constricted area 108. In exemplary arrangements the protrusions are operative to provide a biasing force against the immediately adjacent surface of the link. In exemplary arrangements the protrusions serve to prevent the inadvertent movement of the input device between the first input device position and the second input device position. As a result in the exemplary arrangement the protrusions require that the user apply an inward force to the button head of the input device in order to enable movement between the first and second positions of the input device. Of course it should be understood that while this configuration is useful, it is exemplary and in other arrangements other structures and elements may be utilized to maintain the input device in the user set position.

FIGS. 41-58 show further alternative arrangement which enables the user to selectively operate the triggers of the controller to provide inputs in a first mode of operation corresponding to each position of the trigger within the full range of movement, or in a second operational mode that limits trigger movement to a stop position in which signals are received from a trigger stop switch.

FIG. 41 shows a schematic view of a trigger 34 of a game controller similar to those triggers previously discussed. A link 112 extends within the body of the game controller and is selectively rotationally positionable by a user through movement of an input device that is accessible on the exterior of the controller body. When the link is rotated to the position shown in phantom in FIG. 41 the trigger is movable from the outward position to the fully inward position shown in phantom, and each position in which the trigger is located within the full range of movement is detectable by the circuitry from signals produced by the position sensor 42. Alternatively when the link is rotated to the position shown in solid lines in FIG. 41, movement of the trigger is limited from the outward position to a stop position at which the trigger engages the link 112. The link is operative to move an actuator 114 of a trigger stop switch 116 from a first actuator position to a second actuator position. As a result the trigger moves only a small portion of its total range of movement from the outward position, to change condition of the trigger stop switch. This mode of operation facilitates the user's rapid provision of inputs via movement of the trigger.

In the exemplary arrangement the link 112 is rotatable responsive to movement of a knob 118, an outer portion of which is accessible by a user from outside the body. The outer portion of the knob extends through an opening 120 in the body 12 and is rotatably movable to selected positions by the user of the controller. As a result the knob serves as an input device that is movable between a first input device position and a second input device position responsive to manual rotation thereof. The exemplary knob includes an axially centered rectangular passage that extends therethrough, which corresponds to a rectangular configuration of an external surface portion of the link within the interior of the knob. This enables the link to be relatively movable along the axis of the link within the knob while maintaining the link in operatively fixed rotatable connection with the knob.

In some exemplary arrangements the link 12 may be rotatable about an axis of the link, and movable along the axis of the link, while being supported within a guide 122. In some exemplary arrangements the guide 122 may be in operatively fixed connection with the body 12. The exemplary guide 122 is operative to hold the link 112 such that an outer link end 124 that extends outside the knob 118 is maintained in aligned relation with the actuator 126 of the trigger stop switch 116.

In FIGS. 42, 43, 48 and 49 the link 112 is shown in the second link position. In this position the inner end 128 of the link 112 is positioned to engage an inner side of the trigger when the trigger is moved inward to a stop position. As the trigger is moved from the outward position to the stop position, which is only a small portion of the potential overall range of movement of the trigger to the fully inward position, the link is moved inwardly. The portion of the link within the guide 122 and within the knob 114 moves relative to the guide and the knob and presses against the actuator 126 of the trigger stop switch. The link moves the actuator inward to the body of the trigger stop switch to the second actuator position. As a result, movement of the link changes the actuator from the first actuator position to the second actuator position. Similar to the other exemplary arrangements movement of the actuator to the second actuator position causes a tactile click that is perceivable by the user's finger in engagement with the trigger. In the exemplary arrangement the actuator which is biased towards the first position, moves the link along its respective axis back to its initial position when the trigger is released.

FIGS. 44 and 45 show the exemplary link 112 in the first link position. When the link 112 is moved to the first link position responsive to rotation of the knob 114, the inner link end 128 is moved to a position that is disposed away from the trigger 34. As a result in the second link position the trigger 34 is enabled to move between the outer position and the fully inward position, with the current position of the trigger along the entire range of movement being detectable responsive to operation of the position sensor.

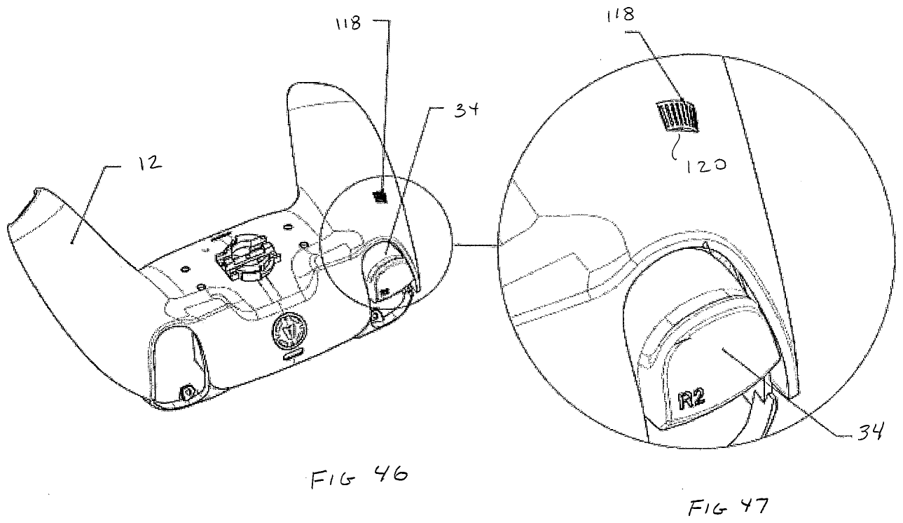

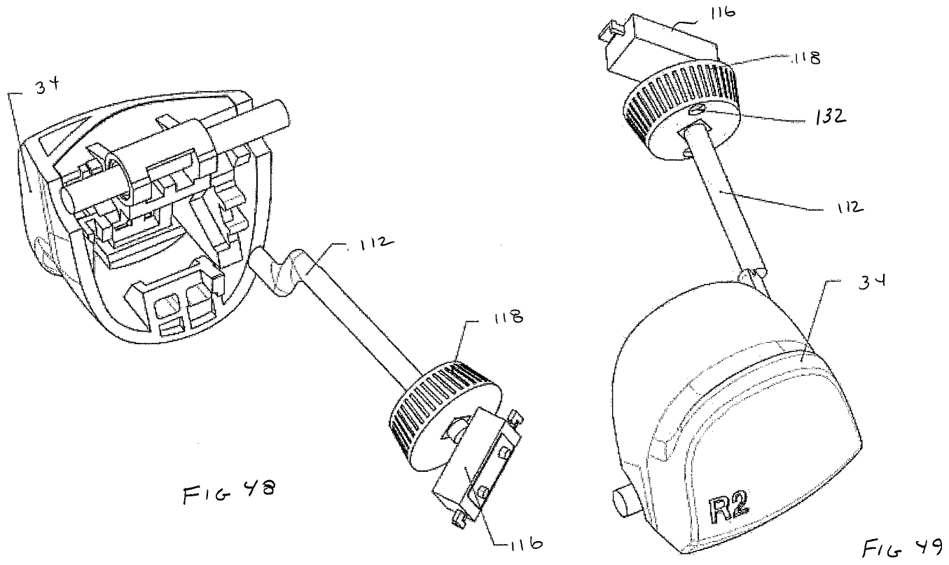

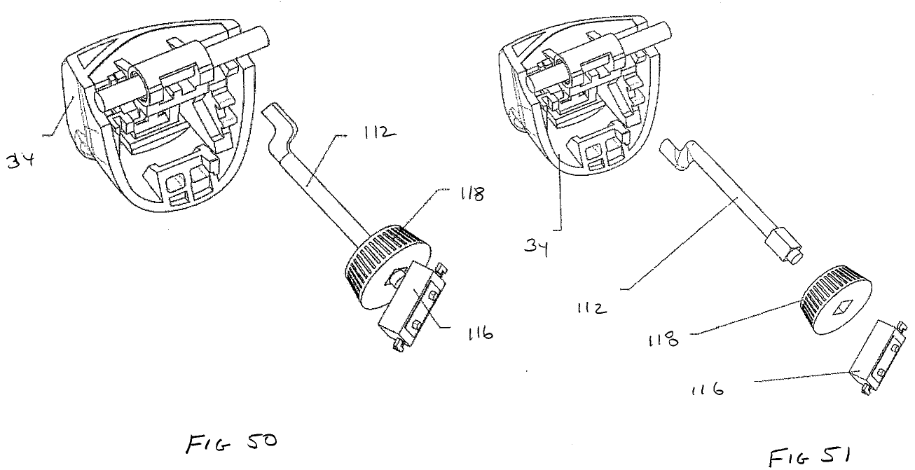

FIGS. 46 and 47 show the lower surface of the body 12 with the opening 120 through which a portion of the knob 118 extends. As a result of this exemplary configuration the user is enabled to quickly rotate the knob so that the knob serves as an input device that changes between the first input device position and the second input device position. The rotation of the knob changes the link between the first link position and the second link position.

In some exemplary arrangements the knob 118 serves as an input device that is specifically adapted to assure that the user moves the knob precisely between the first input device position and the second input device position. This helps to assure that the link 112 is not outside one of the defined first and second link positions, which may result in the trigger not properly changing the condition of the trigger stop switch or not being able to move throughout its full range of movement. Further in some exemplary arrangements it is desirable to assure that the input device does not inadvertently move out of either the first input device position or the second input device position during game play.

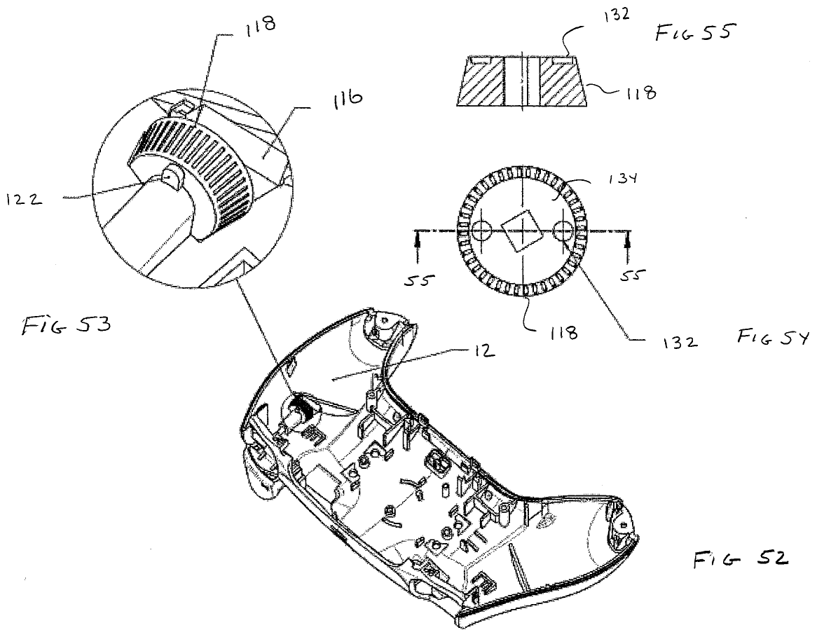

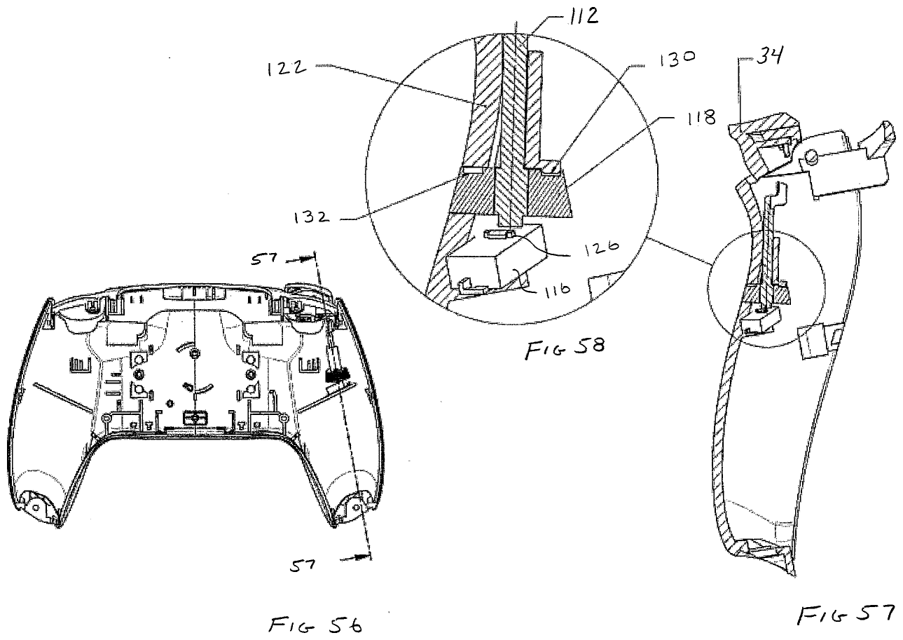

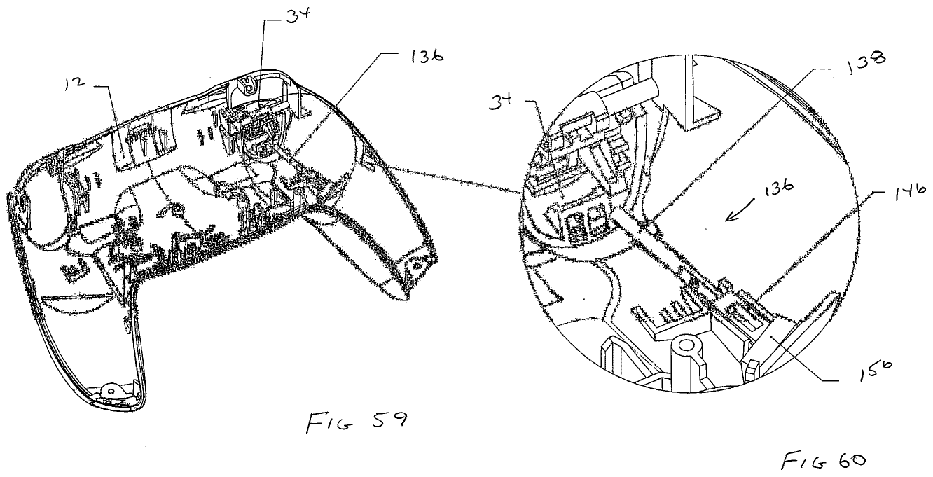

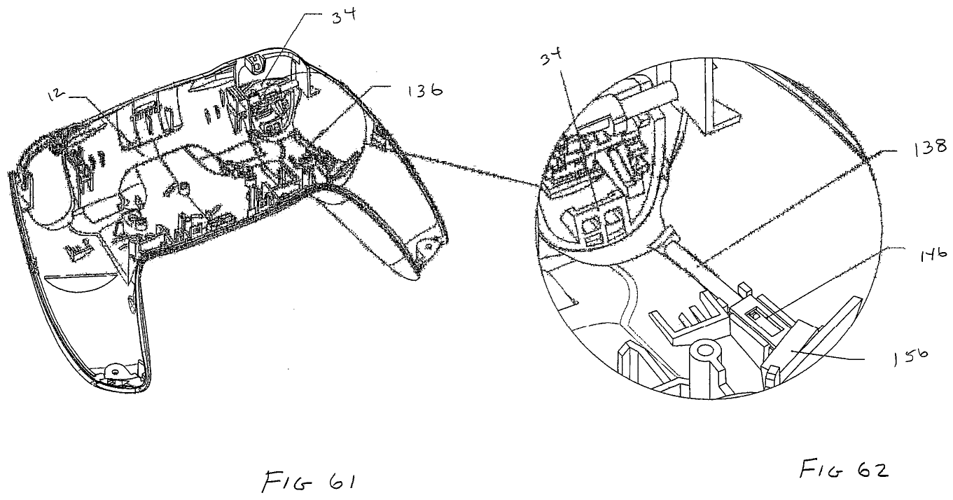

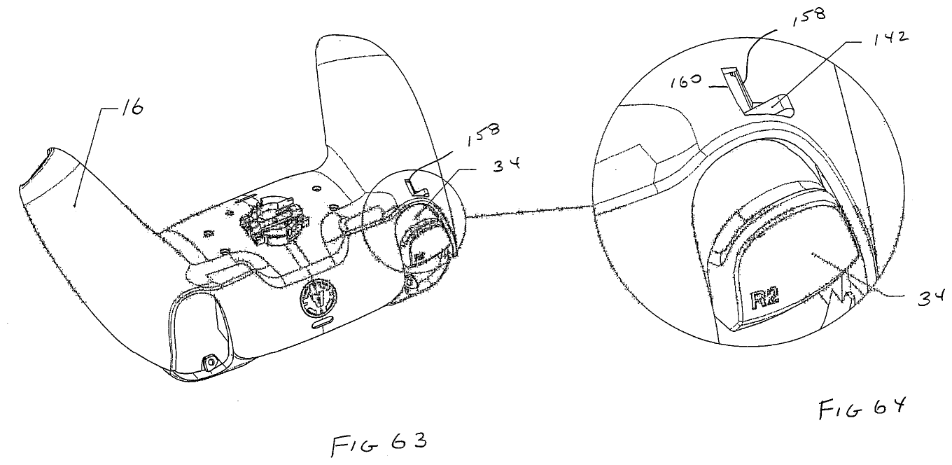

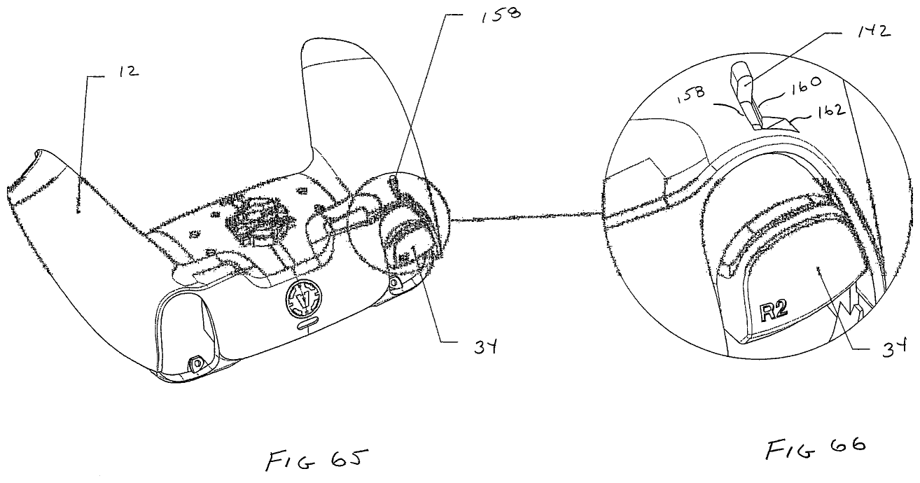

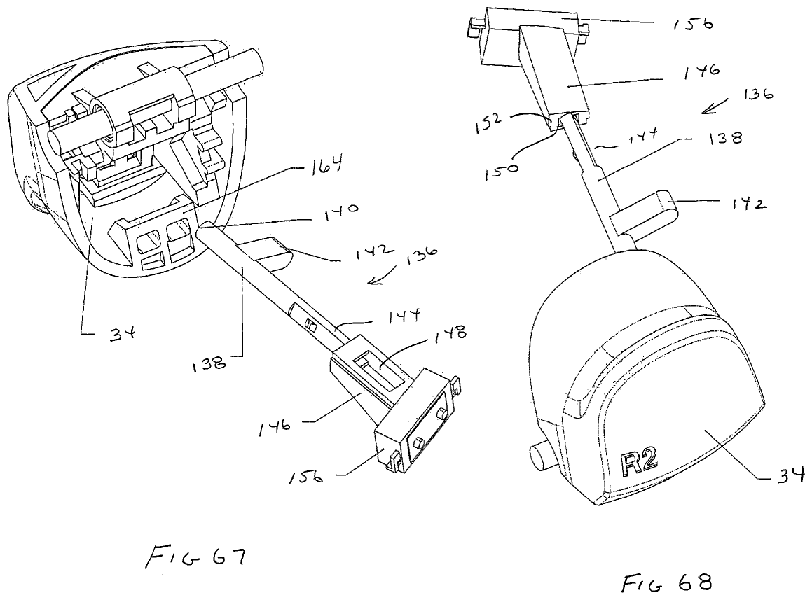

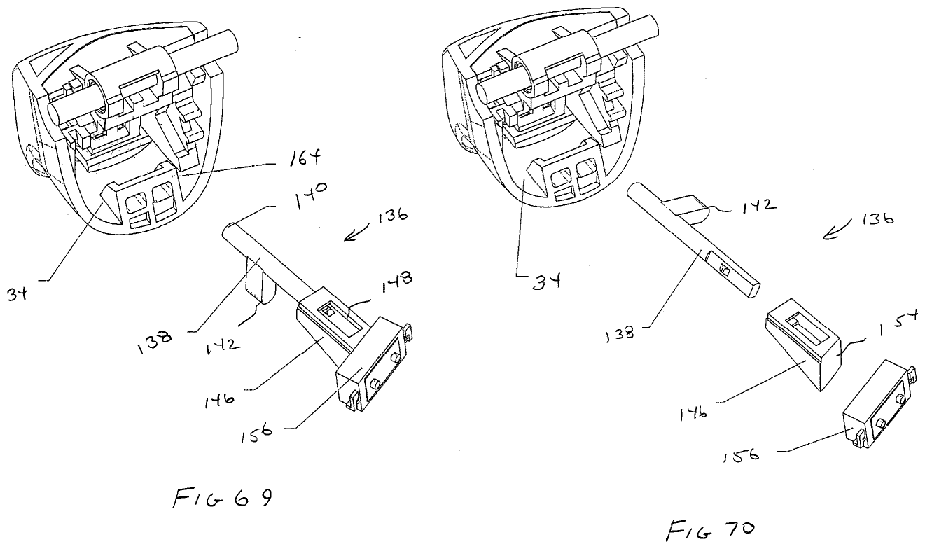

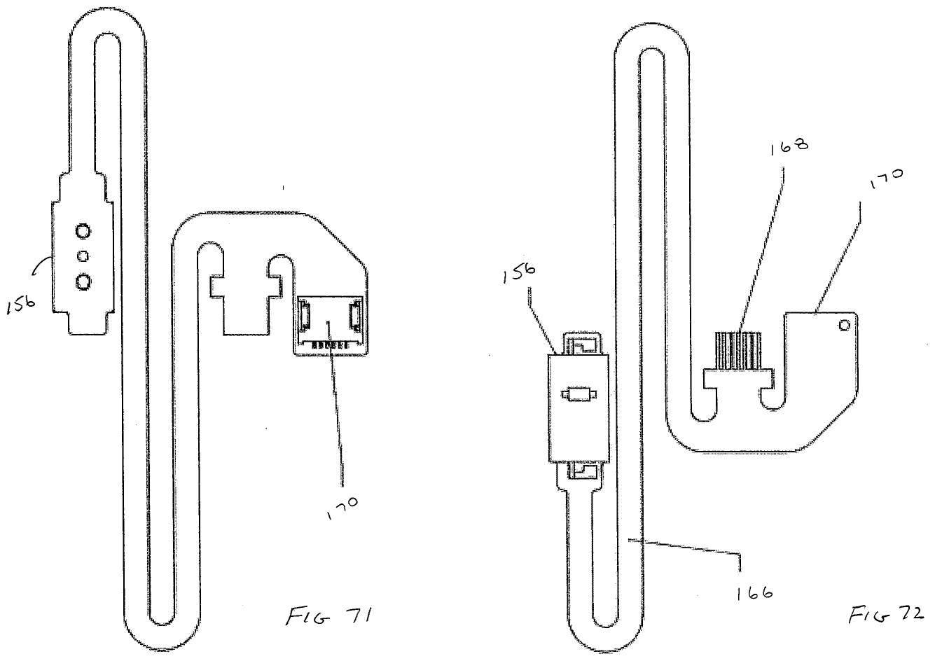

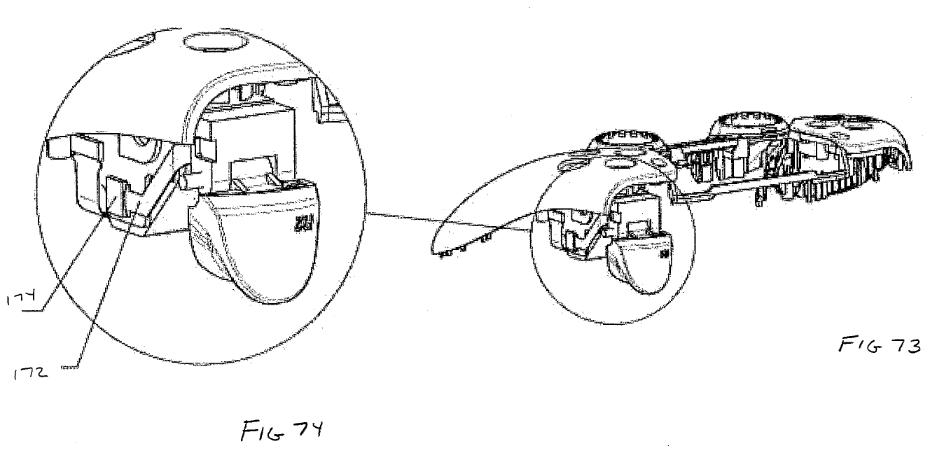

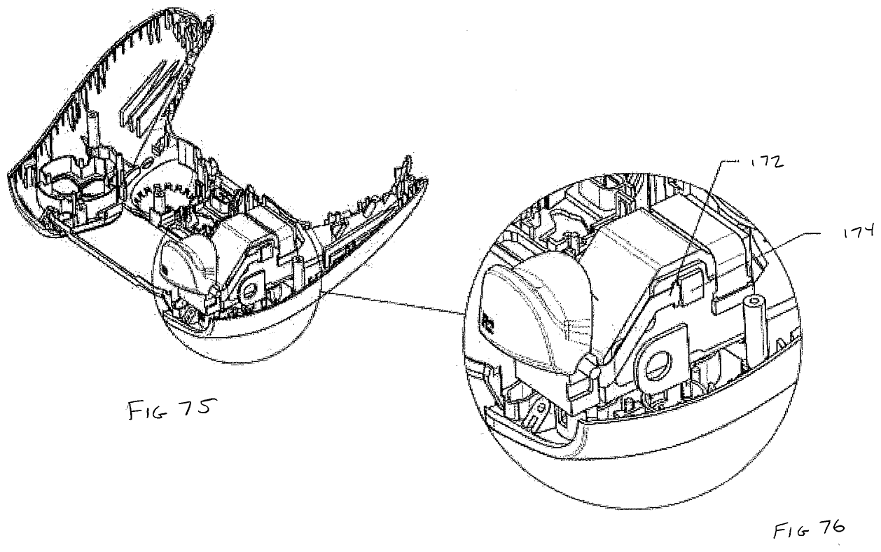

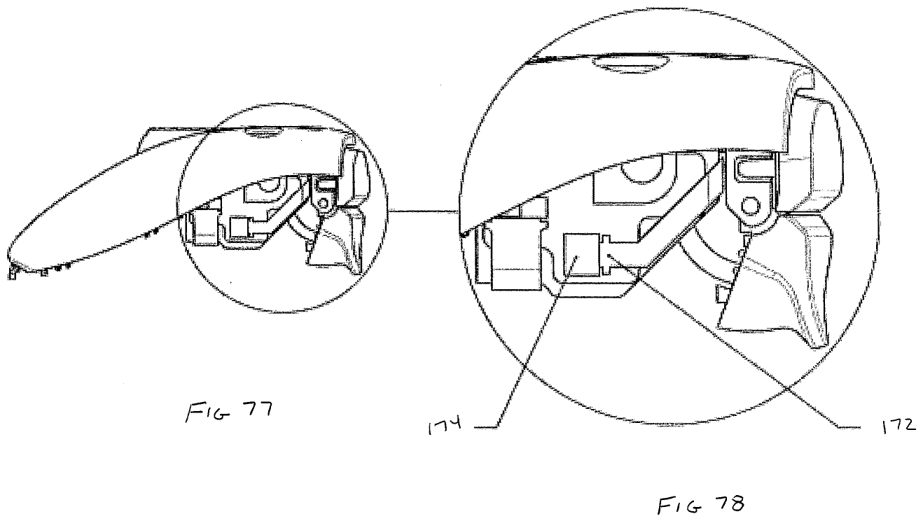

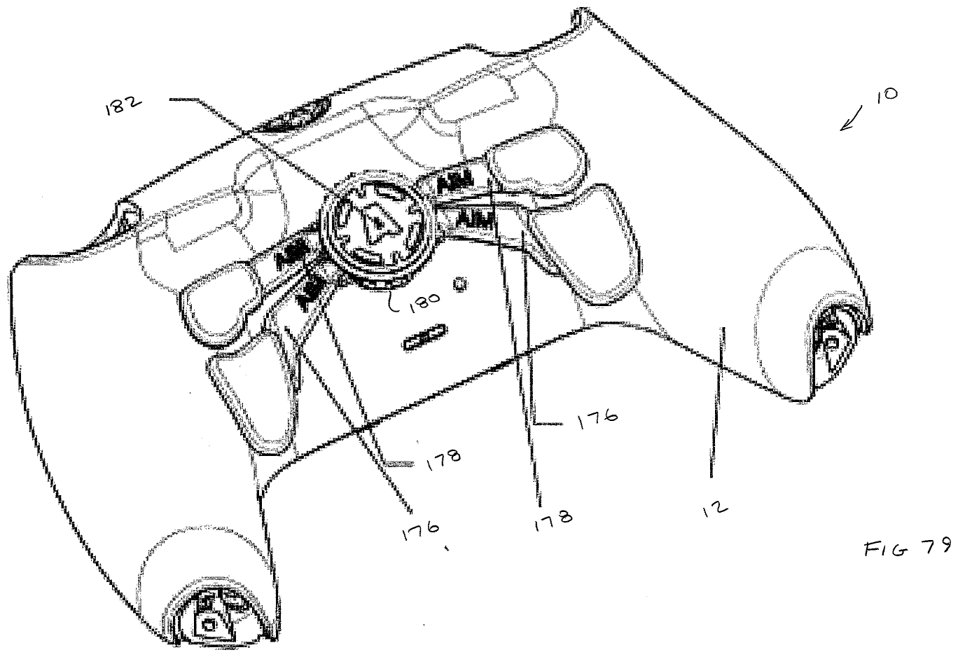

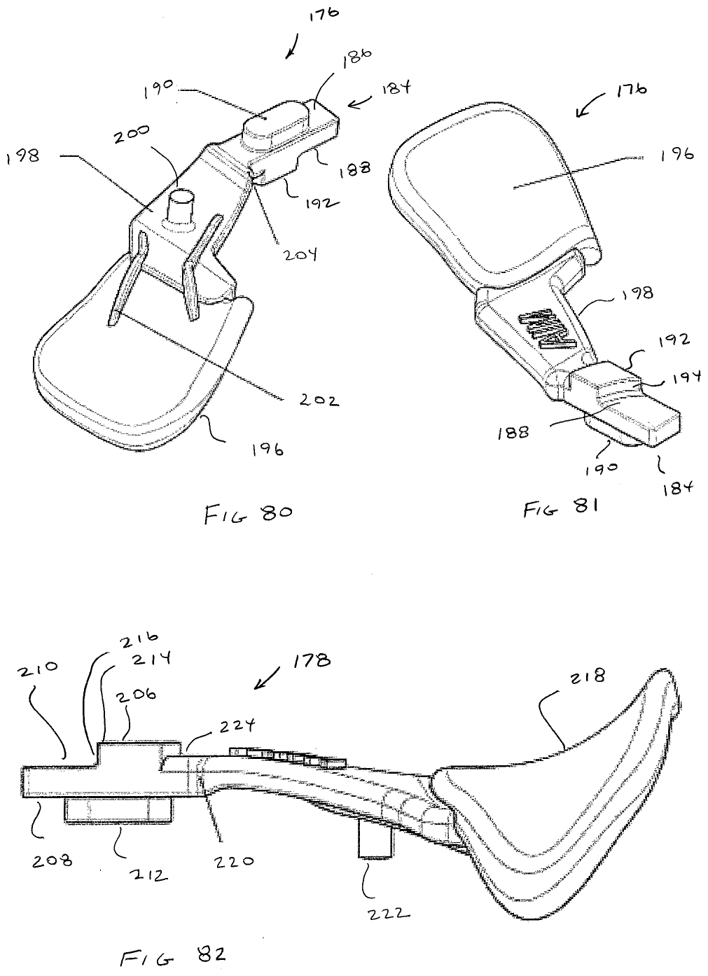

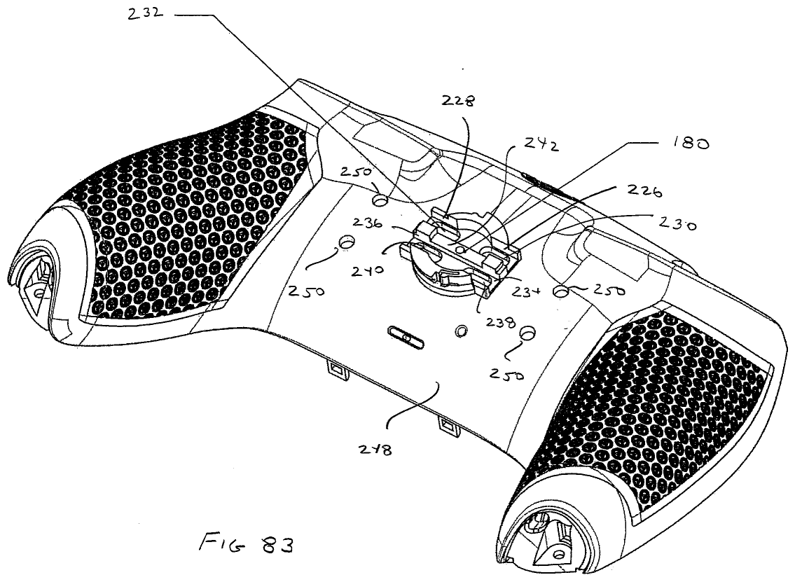

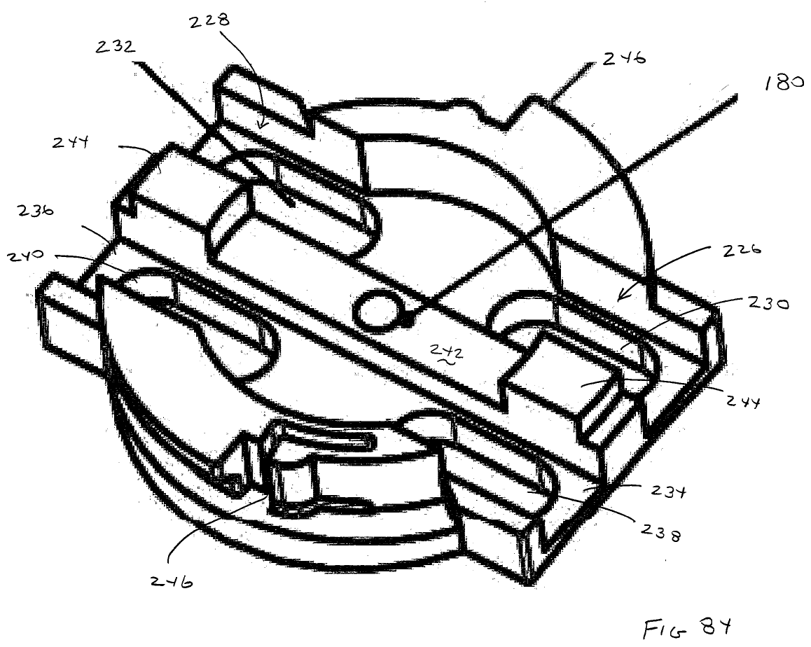

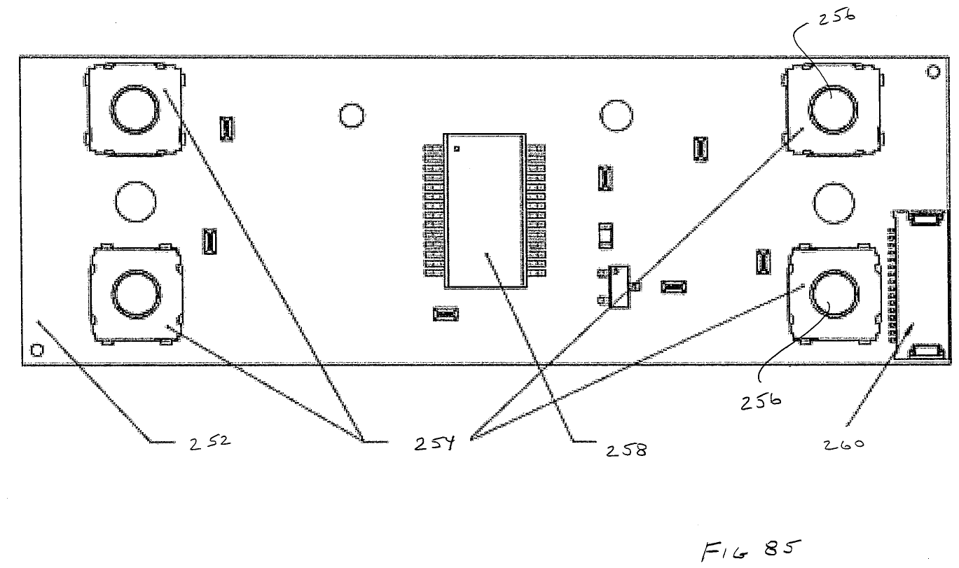

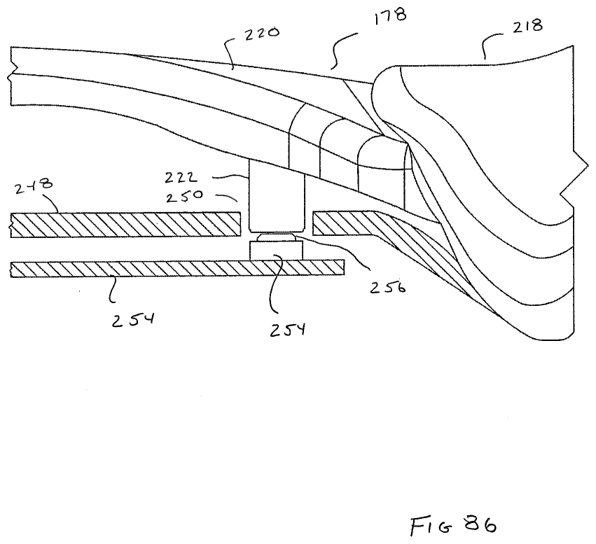

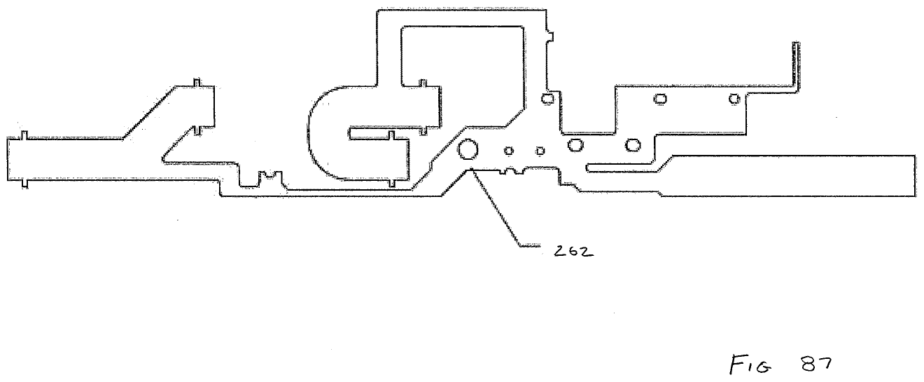

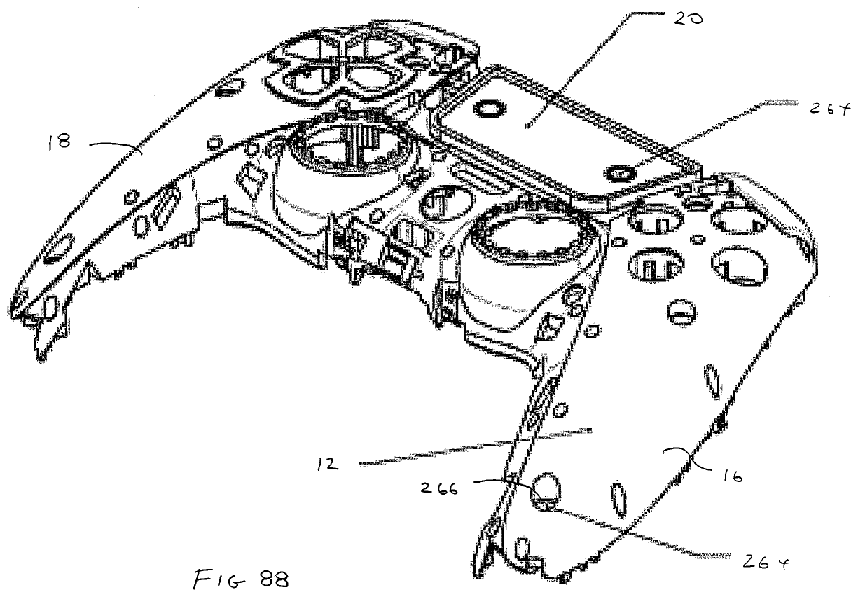

As shown in FIGS. 53-58 in some exemplary arrangements a detent arrangement is utilized to assure that the input device is held in its user set position and is maintained in that position even if the externally exposed area of the knob may be inadvertently contacted during game play. In the exemplary arrangement the detent comprises a projection 130 that extends on the guide 122. The exemplary projection is configured to releasably engage in recesses 132 that extend in a guide face 134 that is in facing relation with the projection on the guide 122. In the exemplary arrangement the recesses 132 are spaced 180° apart. In this exemplary arrangement this spacing corresponds to the angle that the link 112 rotates between the first link position and the second link position. As a result, in the exemplary arrangement the user is enabled to change the link between the first link position and the second link position by rotating the knob 118 in either rotational direction. This makes it easier for the user to change the configuration of the triggers between the two alternative modes of operation.

It should be understood that in exemplary arrangements the inner end of the link 112 may have various shapes to facilitate engagement with the trigger in the second link position. Further the exemplary inner end may be configured so that the link is engageable with the trigger throughout a range of rotational positions of the knob.

Further in some exemplary arrangements the knob may have different outer surface configurations and/or be comprised of different materials to enhance ergonomics and facilitate use. In some exemplary arrangements different surface finishes for the knob such as by photochemical treatment, laser engraving or sandblast forming of a cavity within the knob may provide useful properties of the knob. Further in exemplary arrangements the knob may include bands, grooves, longitudinal, transverse, or oblique valleys or protrusions of different shapes and sizes to enhance appearance and/or to facilitate use. Of course it should be understood that these approaches while useful are exemplary and in other arrangements other approaches may be used.

FIGS. 59-70 show a further alternative exemplary controller arrangement in which a trigger may be changed between two different modes of operation that are similar to those modes of operation previously discussed. As shown for example in FIGS. 67-70, a link 136 comprises a rotatable portion 138. The rotatable portion includes a link inner end 140 and an outward extending protrusion 142. The protrusion 142 is alternatively referred to herein as a projection. The rotatable portion further includes a profiled outer end 144 having a particular outer surface profile that is other than round.

The exemplary link 136 further includes a slider block 146. The slider block includes a passage 148 into which the profile end 144 may extend. The exemplary passage includes a profile opening 150. The profile opening 150 is configured to accept the profile end 144 in sliding relation therein when the profile opening and the profile end are rotatably positioned to be in alignment. When the profile opening 150 and the profile end 144 have aligned configurations the profile end 144 may move within the passage 140 of the slider block in telescoping relation. In some exemplary arrangements a spring or other biasing mechanism may be provided so that the rotatable portion 138 is biased outward from the slider block toward an outer position. However when the rotatable portion 138 is positioned such that the profile end 144 and the profile opening in the slider block 150 are not in conforming aligned relation, the bounding surface 152 of the slider block 146 and in the profile end are in abutting relation.

The exemplary slider block 146 includes an actuating end 154. The actuating end 154 is at an opposed end of the slider block from the profile opening 150. The actuating end 154 is planar and configured to engage an actuator of a trigger stop switch 156. The actuator of the trigger stop switch may be similar to the actuators on the other trigger stop switches previously discussed.

As shown in FIGS. 63 through 66 the exemplary controller body 12 includes a generally L-shaped slot 158. The L-shaped slot 158 extends through the body and is configured to receive the projection or protrusion 142 therein. The exemplary slot includes a first leg portion 160. The first leg portion 160 extends in generally parallel relation with the trigger movement direction. The exemplary slot further includes a second leg portion 162. The second leg portion extends transverse to the first leg portion. In exemplary arrangements the protrusion 142 extends sufficiently outward from the body beyond the slot 158 so that the protrusion may be manually positioned in either the first leg portion 160 or second leg portion 162.

In the exemplary arrangement when the protrusion 142 is positioned in the first leg portion, the profile end 144 of the rotatable portion 138 and the profile opening 150 in the bounding surface 152 are in aligned relation such that the profile end of the rotatable portion may move within the slider block 146 in telescoping relation. As a result an inner surface 164 of the trigger may engage the link inner end and move the rotatable portion 138 inward into the passage 148 of the slider block 146 without the application of force to the slider block sufficient to change the actuator of the trigger stop switch between the first actuator position and the second actuator position. As a result in this exemplary configuration of the link 136 the position of the trigger may move through the full range of movement to the fully inward position, and the position of the trigger is detectable through operation of the position sensor.

Changing the position of the protrusion to extend in the second leg portion 162 causes the profile end 144 to no longer be in conforming alignment with the profile opening 150 of the slider block 146. As a result a relatively small amount of trigger movement from the outward position is operative to cause the rotatable portion 138 to push against the bounding surface of the slider block 146 and cause the actuator of the trigger stop switch 154 to change between the first actuator position and the second actuator position. In the exemplary arrangement sufficient clearance is provided in the second leg portion 162 to enable sufficient movement of the link in response to trigger engagement to change the condition of the actuator. Further in the exemplary arrangement with the protrusion 162 within the second leg of the L-shaped slot, a further solid stop in the stop position for movement of the trigger is provided. Additionally the exemplary actuator of the trigger stop switch when changing from the first actuator position to the second actuator position, provides a tactilely perceivable click to the user's finger that is in engagement with the trigger.

This exemplary arrangement enables a user to readily change the protrusion which serves as an input device, between the first input device position in which the link is in a first link position in which movement of the trigger does not actuate the trigger stop switch, to the second input device position in which the link is in the second leg and movement of the trigger actuates the trigger stop switch. Of course it should be understood that this configuration while useful, is exemplary and numerous other different arrangements may be utilized.

In exemplary arrangements the exemplary trigger stop switches and the circuitry included in the video game controller may be electrically connected through a band connector 166 as shown in FIGS. 71-73. The exemplary band connector is configured to electrically connect a trigger stop switch such as trigger stop switch 156 for example. The band connector 166 may be made of a flexible laminate material for example. The signals from the trigger stop switch are supplied to the other console circuitry via a band connector 168 that is inserted into a socket 170 of the controller circuitry to integrate a trigger stop switch function into the circuitry.

As can be appreciated the exemplary arrangement is configured such that when the input device associated with a trigger is in the first input device position, the associated link is in the first link position and the trigger stop switch is not operational. As a result the trigger is movable throughout the full range of movement and each position of the trigger is detectable via the position sensor. However moving the input device associated with the trigger to the second input device position causes the associated link to be in the second link position. This causes the trigger stop switch to be operational responsive to trigger movement. In this exemplary arrangement the band connector provides the signals from the trigger stop switch to the other circuitry of the controller. As a result when the input device is in the second input device position the signals that are deliverable via the band connector are enabled to be combined through the exemplary circuitry which receives signals from the position sensor through an exemplary connector 172 through a socket 174. Of course it should be understood that this arrangement is exemplary and in other arrangements other electrical connector configurations and circuitry may be utilized.

It should be understood that although in the exemplary arrangement the input devices which are utilized to change the operational mode of the triggers are found in the bottom side of the controller body, in other exemplary arrangements other types of input devices and positioning arrangements for the input devices may be utilized. Numerous different types of structures and elements for the input devices may be utilized. Further in other exemplary arrangements other structures which enable changing the mode of operation of both triggers simultaneously using a single input device rather than individually by respective input devices may be utilized. Further it should be understood that different approaches other than those specifically described herein may be utilized for purposes of holding the input devices in the desired first or second positions and for preventing the input devices from being inadvertently moved during game play. Numerous different arrangements may be implemented utilizing the principles that have been described herein.

The exemplary video game controller provides the capability for a user to selectively add additional input devices. In the exemplary arrangement controller 10 provides the user with the capabilities to add up to four finger actuated paddles as input devices which are actuatable on the bottom side of the controller as shown in FIG. 79. In the exemplary arrangement two smaller paddles 176 and two larger paddles 178 may be added by a user as desired. Of course it should be understood that the number and arrangement of the paddles shown in FIG. 79 is exemplary and different configurations and numbers of paddles may be used.

In the exemplary arrangement each of the paddles is releasably engaged to the controller body through a socket 180 which is later described herein in detail. A socket cover 182 is releasably engageable with the socket 180. In the engaged position the socket cover is operative to hold the paddles in engagement with the socket.

As shown for example in FIGS. 80-82 each of the paddles 176, 178 include similar features. For example each of the small paddles 186 includes a base portion 184. The exemplary base portion has a generally rectangular configuration. The base portion includes an inner facing side 186 and outer facing side 188. The inner facing side 186 includes a base projection 190 that extends therefrom. The exemplary base projection 190 is an elongated oval-shaped projection that is bounded inwardly by a planar inner surface. The outer facing side 188 includes an outward extending step 192. The outward extending step is bounded by a curved portion 194. In exemplary arrangements the curved portion corresponds to an outer periphery of the socket cover 182 which in the operative position of the paddle extends adjacent to and in overlying relation of the base portion 184.

The exemplary paddle 176 further includes a pad portion 196. The pad portion 196 is configured to be finger engageable by a user's fingers during operation of the paddle. An arm portion 198 extends intermediate of the base portion and the pad portion. The arm portion 198 includes a switch actuating projection 200. The switch actuating projection 200 extends downward from the arm portion intermediate of the pad portion 196 and the base portion 184. In the exemplary arrangement the paddle is a unitary molded structure comprised of resilient deformable material such as plastic, and includes reinforcing ribs 202 that strengthen the joined relation between the pad portion 196 and the arm portion 198. The exemplary paddle further includes a flexible joint area 204 that extends intermediate of the base portion 184 and the arm 198. In the exemplary arrangement the joint area 204 enables flexible resilient relative movement of the arm and the base portion which occurs during operation responsive to finger engagement with the pad portion. In exemplary arrangements the paddles 176 are configured in left and right hand configurations which are respective mirror images of one another such as is shown in FIG. 79.

The larger paddles 178 include similar features to the smaller paddles. The larger paddles include a base portion 206 that has a similar rectangular configuration to the base portion 184. Base portion 206 includes an inner facing side 208 and outer facing side 210. A base projection 212 that is similar to base projection 190 extends from the inner facing side. The outer facing side includes an outward extending step 214 that is bounded by a curved portion 216.

The exemplary paddle 178 further includes a pad portion 218. The pad portion 218 is configured for finger engagement and is somewhat larger and has a finger engaging surface that is more concave than the pad portion 196 of the smaller paddle 176. An arm 220 extends intermediate of the base portion 212 and the pad portion 218. A cylindrical switch actuating projection 222 extends from a lower side of the arm 220 intermediate of the pad portion and the base portion. The exemplary paddle 178 also includes a flexible joint area 224 intermediate of the arm portion and the base portion. The exemplary paddle may further include reinforcing projections of the type previously discussed. Similar to the paddles 176, the larger paddles 178 may be produced in left and right hand configurations which are mirror images of one another.

The exemplary socket 180 is shown with the socket cover disengaged therefrom in FIGS. 83 and 84. The exemplary socket 180 includes a pair of opposed generally rectangular first socket channels 226, 228. Each respective socket channel 226, 228 includes a socket recess 230, 232 that extends inward in the body on a lower surface thereof. The exemplary socket further includes a pair of aligned second socket channels 234, 236, each of which have a respective socket recess 238, 240 that extends inward in the body from the lower surface thereof. In the exemplary socket configuration a central divider 242 separates the first and second socket channels. The exemplary divider 242 includes projection portions 244 thereon which are configured to engage the inward facing surface of the socket cover 182 when the socket cover is engaged with the socket.

The exemplary socket further includes thereon socket cover engaging projections and recesses 246. The cover engaging projections and recesses are configured to releasably engage corresponding engaging projections and recesses on the socket cover. The engaging projections and recesses enable the socket cover to be engaged with the socket and released from engagement with the socket by rotation of the socket cover relative to the socket.

In the exemplary arrangement a base portion of a respective paddle is configured to be positioned in a respective socket channel of the socket. When the base portion is positioned in the respective socket channel, the base projection of the base portion extends within the corresponding socket recess associated with the respective socket channel. As previously discussed in the exemplary arrangement from zero to four paddles may be engaged with the respective socket. With the base portions of respective paddles engaged with the socket, installation of the socket cover 182 in engagement with the socket causes the base portions to be held sandwiched in intermediate relation between the socket and the socket cover.

As shown for example in FIG. 79 when the paddles are engaged with the socket and held in place by the socket cover, the pad portions of each of the paddles is angularly disposed away from the pad portions of each of the other paddles. Further each pad portion extends in overlying relation but is disposed away from the surface 248 of the lower side of the body. In the operative position of each paddle the respective pad portion and engaged arm portion of the paddle is movable toward the underlying body surface 248 by finger engagement. Such finger engagement causes the elastic deformation of the arm relative to the respective base portion of the paddle which returns to its original position when the user disengages their fingers from the pad portion. Of course it should be understood that this arrangement while useful, is exemplary and in other arrangements other approaches may be used.

The exemplary surface 248 includes a plurality of switch actuating projection openings 250. Each of the switch actuating projection openings is configured to receive a switch actuating projection in movable relation therein. In the exemplary arrangement a circuit board 252 having the configuration shown in FIG. 85 is positioned in the body and in underlying relation of the switch actuating projection openings 250. The circuit board 252 includes four paddle switches 254. Each of the paddle switches includes a paddle switch actuator 256. Each paddle switch actuator is movable relative to the respective paddle switch between a first paddle switch position in which the paddle switch actuator extends outwardly from the paddle switch, and a second paddle switch position in which the paddle switch actuator is moved inwardly into the paddle switch. In exemplary arrangements the paddle switch actuators are biased outwardly toward the first paddle switch position. Each of the exemplary paddle switches 254 are operative to electrically change between a first paddle switch condition and a second paddle switch condition responsive to movement of the paddle switch actuator between the first and second paddle switch positions.

As the paddle switches change conditions electrical signals produced by the paddle switches are communicated to circuitry 258 on the circuit board 252. The electrical signals communicated by the paddle switches are indicative of the current paddle switch conditions. An electrical connector 260 on the circuit board 252 is operative to communicate signals from the circuitry 258 to the other circuitry in the controller.

As shown in FIG. 86, when a paddle is in the operative position the switch actuating projection such as for example switch actuating projection 222 on paddle 178 extends in and is movable in a respective switch actuating projection opening 250. Movement of the pad portion toward the surface 248 of the body is operative to cause engagement of the switch actuating projection and the paddle switch actuator 256 of the paddle switch 254. As a result the paddle switch actuator moves to a second paddle switch position which causes the paddle switch to change from a first paddle switch condition to a second paddle switch condition. Finger disengagement from the pad portion 218 then causes the resilient paddle to cause the arm portion 220 to again move further away from the surface 248 of the body. As a result the switch actuating projection 222 moves outwardly in the switch actuating projection opening 250. This causes the paddle switch actuator to move from the second paddle switch actuator position to the first paddle switch actuator position which causes the paddle switch 254 to be in the first paddle switch condition.

As a result the electrical signals indicative of the conditions of the paddle switches enable a user to provide inputs to the controller to control different aspects of game play. Further the exemplary arrangement enables a user to change the number and configurations of paddles that are engaged with the socket as may be necessary for the different types of game play for which the controller is to be used. Further in the event that a paddle is broken, a user is enabled to readily replace the broken paddle by disengaging the socket cover 182 from the socket 180, and removing the base portion of the broken paddle from the socket channel. A replacement paddle may then have the respective base portion thereof installed in the respective socket channel, the socket cover reinstalled and the controller returned to normal operation.

In the exemplary arrangement a flexible electrical connector 262 shown in FIG. 87 may be utilized to connect the circuit board 252 to the other circuitry in the video game controller. The exemplary electrical connector includes suitable engaging connections to connect the socket connector 260 and the other circuit connectors to which the circuit board is electrically connected. Of course it should be understood that this electrical connector configuration is exemplary and in other arrangements other connection arrangements may be used.

The exemplary circuitry of the video game controller and/or a connected video game console includes circuit executable instructions which enable a user to change the operational functions of the different buttons that are included on the controller. This includes in the exemplary arrangement the ability to selectively cause a function carried out through actuation of a switch associated with one of the buttons such as buttons 26 or 28, to be carried out responsive to actuation of one of the paddles 176 or 178. This is accomplished in the exemplary arrangement by the circuitry responsive to receiving signals corresponding to actuation of the switches corresponding to a user pressing a predetermined sequence of buttons, and/or a particular paddle, to cause the actuation of the paddle switch to provide a controller input that is used by the circuitry of the controller in place of the signal that is initially caused by actuation of the particular button switch. For example in exemplary arrangements the sequence of button actuations may include pressing and holding all the paddles depressed inwardly for 10 seconds so as to change the conditions of the paddle switches which produce signals, which cause the circuitry to enter a configuration mode. Then, a user may press and hold simultaneously depressed for two seconds, a selected paddle and a selected button on the controller. In exemplary arrangements the circuitry in the configuration mode operates to assign the function of the selected button to actuation of the selected paddle. In the exemplary arrangement thereafter pressing and holding depressed all four of the paddles concurrently for 10 seconds saves the new configuration setting and causes the circuitry to exit from the configuration mode.

For example if the user wishes to assign the functionality of the up arrow button 26 to a selected one of the paddles, the user would depress all four paddles for 10 seconds to cause the circuitry enter the configuration mode. The user would then concurrently press and hold the up arrow button and the selected paddle that the user now wishes to serve as the up arrow button, for two seconds and then release both the button and the paddle. The user would then again hold all four paddles depressed for 10 seconds to save the settings and have the circuitry exit from the configuration mode. Thereafter during game play the circuitry will operate responsive to the stored data to cause actuation of the paddle switch associated with the respective paddle selected by the user, to provide a controller input that is used by the circuitry in place of the signal generated by the switch that is actuated by pressing the up arrow button. Of course it should be understood that this particular arrangement for changing the configuration of the input devices of the controller is exemplary and in other arrangements other sequences and approaches may be utilized.

The exemplary controller further provides the capability for a user to selectively change at least one of the appearance or tactile properties of the controller. This is accomplished in exemplary arrangements by installing removable overlays in overlying relation of one or more portions of the outer surface of the controller body.

In certain exemplary arrangements the controller body 12 may have overlay apertures 264 that extend therein. In exemplary arrangements the overlay apertures may be positioned in a plurality of locations on the arm portions 16, 18 of the body. In some exemplary arrangements the overlay apertures may be positioned on or adjacent to the touch panel 20. Further overlay apertures may be positioned in other positions on the controller body as well.

In the exemplary arrangement each of the overlay apertures 264 includes a body magnet 266 positioned therein. In exemplary arrangements the body magnet may be in fixed, recessed relation within the body aperture such that the magnet is below the outer surface of the body immediately adjacent to the body aperture. In some exemplary arrangements the magnets may include neodymium magnets. However these are exemplary and in other arrangements other types of magnetic elements may be used.

To change the appearance of a portion of the outer controller surface an overlay such as overlay 268, may be releasably installed in overlying relation of the console surface. In exemplary arrangements the overlay includes openings 270 therethrough that correspond to the buttons or other features of the underlying body surface. The openings 270 are configured so that the buttons or other devices are accessible to the user through the overlay.

Further in exemplary arrangements the overlay includes overlay magnets 272. The overlay magnets correspond to the positions of the body magnets in the body apertures in the controller surface. In exemplary arrangements the overlay magnets are configured so that when the overlay is installed on the controller body, each overlay magnet is positioned in immediately adjacent relation to a body magnet. This helps to hold the overlay in the desired position and to reduce the risk of separation of the overlay from the controller body during game play.

Further in some exemplary arrangements a touch panel overlay 274 may be releasably positionable in outwardly overlying relation of the touch panel 20. The exemplary touch panel overlay may include overlay magnets 276 in positions which correspond to the body magnets in the body apertures of the touch panel.

In exemplary arrangements the overlays which overlie the body surface may provide different external appearance features such as different coloration or design patterns which the user may find attractive. The user is enabled to change the different overlays and thus change the appearance of the controller as the user may desire through the selection and arrangement of the overlays.

In other exemplary arrangements the exterior surface of the overlays may provide different tactile properties. This enables a user to select a desired tactile feel for the external surfaces of the controller. For example overlays may provide different resilient deflection and cushioning properties that the user may find more appealing during operation of the controller. Alternatively overlays may provide surface properties which enable the user to have a tighter and more stable grip of the controller. By changing the overlays to have the tactile properties that the user desires in the various areas of the surface of the controller, the user can achieve a more desirable game play experience.

Further in some exemplary arrangements overlays may be utilized to provide different external surface contours from the outer surface of the controller. This can be achieved by having the overlays include areas with different contours and thicknesses so that when the overlay is applied to the controller body the outer surface contours on the overlay are more desirable to the particular user.

Further touch panel overlays may provide selected appearance features and/or selected tactile properties in the area of the touch panel. Additionally touch panel overlays may include features which change visual properties such as magnification, polarization or other user desired properties. Of course it should be understood that these described features while useful, are exemplary and in other arrangements other approaches may be used.

It further should be appreciated that while the use of the overlays and magnetic attachment methods described herein are useful for purposes of enabling user selected modifications to the video game controller, other types of attachment methods may be utilized. Such attachment methods may be tailored to the particular overlay structures and requirements of such structures to be held in releasably fixed engagement in a manner that does not cause separation of the overlay from the body of the controller during game play. Additionally, the overlay structures and the controller body may be dimensionally structured so that the use of the overlay structures achieve an outer surface profile for the controller that is desired by the user.

Thus the exemplary arrangements described herein achieve improved operation, eliminate difficulties encountered in the use of prior devices and systems, and attain the useful results described herein.

In the foregoing description, certain terms have been used for brevity, clarity and understanding. However, no unnecessary limitations are to be implied therefrom because such terms are used for descriptive purposes and are intended to be broadly construed. Moreover the descriptions and illustrations herein are by way of examples and the new and useful features and relationships are not limited to the exact features that have been shown and described.

Having described features, discoveries and principles of the exemplary arrangements, the manner in which they are constructed and operated, and the advantages and useful results attained, the new and useful features, elements, devices, arrangements, parts, combinations, systems, equipment, operations, methods, processes and relationships are set forth in the appended claims.

I claim:

1. Apparatus comprising:
a video game controller configured to receive user inputs in conjunction with video game activity, including:
a body,
a pair of finger movable triggers, wherein the triggers are disposed from one another on the body,
wherein each trigger is
movably mounted in operative connection with the body,
biased toward an outward position on the body,
movable in a constrained trigger range of movement responsive to finger contact with the trigger between the outward position and a fully inward position,
a pair of position sensors, wherein each position sensor is
housed within the body,
in operative connection with a respective trigger,
operative to provide at least one signal indicative of each current position of the respective trigger within the trigger range of movement,
a pair of trigger stop switches, wherein each trigger stop switch
is housed within the body,
includes an actuator that is
movable between a first actuator position and a second actuator position,
biased toward the first actuator position,
operative to provide at least one signal indicative of whether the actuator is in the first actuator position or the second actuator position,
a pair of links, wherein each link
is movably mounted within the body,
is movable between a first link position and a second link position,
wherein in the first link position the link does not cause operative engagement of a respective trigger and a respective actuator of a respective trigger stop switch anywhere within the trigger range of movement, and
wherein in the second link position the link causes the respective trigger and the respective actuator of the respective trigger stop switch to be operatively engaged such that when the respective trigger is moved from the outward position to a stop position which corresponds to only a portion of the trigger range of movement toward the fully inward position, the respective trigger is
prevented from moving further toward the inward position, and
operative to cause the actuator to be moved from the first actuator position to the second actuator position,
a pair of input devices, wherein each input device is
manually accessible from outside the body,
manually movable between a first input device position and a second input device position,
in operative engagement with a respective link,
wherein in the first input device position the respective link is caused to be in the first link position, and in the second input device position the respective link is caused to be in the second link position.

2. The apparatus according to claim 1
wherein when a respective link is in the second link position and the respective associated trigger is moved to the stop position, movement of the respective actuator that is operatively engaged with the respective trigger to the second actuator position is operative to cause the respective trigger to receive a tactilely perceivable click.

3. The apparatus according to claim 1
wherein each input device comprises one of
a slidable button,
a rotatable knob, or
a movable projection.

4. The apparatus according to claim 1
wherein each trigger stop switch includes a stop switch body, wherein the stop switch body includes an actuator opening,
wherein the respective actuator is movable in the actuator opening, wherein in the first actuator position the actuator extends further outward from the actuator opening than in the second actuator position.

5. The apparatus according to claim 1
wherein each trigger range of movement is along a respective trigger movement direction,
wherein movement of the respective link associated with the respective trigger from the first link position to the second link position, causes one of
the respective trigger stop switch to be moved transversely to the trigger movement direction, wherein in the stop position of the respective trigger the respective actuator is in the second actuator position, or
the link to be moved transversely to the trigger movement direction, wherein in the stop position of the respective trigger, the link is operatively engaged with the respective trigger.

6. The apparatus according to claim 1
and further comprising:
a paddle, wherein the paddle includes
a base portion, wherein the base portion includes an inner facing side and an outer facing side, wherein a base projection extends from the inner facing side,
a finger engageable pad portion, wherein the pad portion is disposed away from the base portion and is configured to move responsive to finger engagement therewith,
an arm portion, wherein the arm portion extends intermediate of the base portion and the pad portion, wherein the arm portion includes a switch actuating projection intermediate of the base portion and the pad portion,
wherein the body further includes a socket, wherein the socket includes
a socket channel, wherein the base portion extends in the socket channel, and
a socket recess, wherein the base projection is engaged in the socket recess,
wherein when the base portion is engaged in the socket channel and the base projection is engaged in the socket recess, the arm portion and the pad portion are disposed away from the socket,
a socket cover, wherein the socket cover is releasably engageable with the socket,
wherein when the socket cover is engaged with the socket
the base portion is held in intermediate relation between the socket cover and the socket,
the base projection is held in the socket recess, and
the pad portion is disposed away from an outer surface of the body,
a paddle switch, wherein the paddle switch
includes a paddle switch actuator,
is changeable between a first paddle switch condition and a second paddle switch condition responsive to movement of the paddle switch actuator,
wherein movement of the pad portion toward the outer surface of the body is operative to cause the switch actuating projection to operatively move the paddle switch actuator such that the paddle switch is caused to change from the first paddle switch condition to the second paddle switch condition.

7. The apparatus according to claim 1
and further comprising:
a paddle, wherein the paddle includes a
a base portion, wherein the base portion includes an inner facing side and outer facing side, wherein a base projection extends from the inner facing side,
a finger engageable pad portion, wherein the pad portion is disposed away from the base portion and is configured for movement responsive to finger engagement therewith,
an arm portion, wherein the arm portion extends intermediate of the base portion and the pad portion, wherein the arm portion includes a switch actuating projection intermediate of the base portion and the pad portion,
wherein the body further includes a socket, wherein the socket includes
a socket channel, wherein the base portion extends in the socket channel, and
a socket recess, wherein the base projection is engaged in the socket recess,
wherein when the base portion is engaged in the socket channel and the base projection is engaged in the socket recess, the arm portion and the pad portion are disposed away from the socket,
a socket cover, wherein the socket cover is releasably engageable with the socket,
wherein when the socket cover is engaged with the socket
the base portion is held in intermediate relation between the socket cover and the socket,
the base projection is held in the socket recess, and
the pad portion is disposed away from an outer surface of the body,
a paddle switch, wherein the paddle switch
includes a paddle switch actuator,
is changeable between a first paddle switch condition and a second paddle switch condition responsive to movement of the paddle switch actuator,
wherein movement of the pad portion toward the outer surface of the body is operative to cause the switch actuating projection to operatively move the paddle switch actuator such that the paddle switch is caused to change from the first paddle switch condition to the second paddle switch condition,
and wherein when the socket cover is disengaged from the socket the base portion of the paddle is removable from the socket, whereby the paddle is disengageable from the body.

8. The apparatus according to claim 1
and further comprising:
a paddle, wherein the paddle includes a
a base portion, wherein the base portion includes an inner facing side and outer facing side, wherein a base projection extends from the inner facing side,
a finger engageable pad portion, wherein the pad portion is disposed away from the base portion and is configured for movement responsive to finger engagement therewith,
an arm portion, wherein the arm portion extends intermediate of the base portion and the pad portion, wherein the arm portion includes a switch actuating projection intermediate of the base portion and the pad portion,
wherein the body further includes a socket, wherein the socket includes
a socket channel, wherein the base portion extends in the socket channel, and
a socket recess, wherein the base projection is engaged in the socket recess,
wherein when the base portion is engaged in the socket channel and the base projection is engaged in the socket recess, the arm portion and the pad portion are disposed away from the socket,
a socket cover, wherein the socket cover is releasably engageable with the socket,
wherein when the socket cover is engaged with the socket
the base portion is held in intermediate relation between the socket cover and the socket,
the base projection is held in the socket recess, and
the pad portion is disposed away from an outer surface of the body,
a paddle switch, wherein the paddle switch
includes a paddle switch actuator,
is changeable between a first paddle switch condition and a second paddle switch condition responsive to movement of the paddle switch actuator,
wherein movement of the pad portion toward the outer surface of the body is operative to elastically deform the arm portion and to cause the switch actuating projection to operatively move the paddle switch actuator such that the paddle switch is caused to change from the first paddle switch condition to the second paddle switch condition.

9. The apparatus according to claim 1
and further comprising:
a paddle, wherein the paddle includes a
a base portion, wherein the base portion includes an inner facing side and outer facing side, wherein a base projection extends from the inner facing side,
a finger engageable pad portion, wherein the pad portion is disposed away from the base portion and is configured for movement responsive to finger engagement therewith,
an arm portion, wherein the arm portion extends intermediate of the base portion and the pad portion, wherein the arm portion includes a switch actuating projection intermediate of the base portion and the pad portion,
wherein the body further includes a socket, wherein the socket includes
a socket channel, wherein the base portion extends in the socket channel, and
a socket recess, wherein the base projection is engaged in the socket recess,
wherein when the base portion is engaged in the socket channel and the base projection is engaged in the socket recess the arm portion and the pad portion are disposed away from the socket,
a socket cover, wherein the socket cover is releasably engageable with the socket,
wherein when the socket cover is engaged with the socket the base portion is held in intermediate relation between the socket cover and the socket,
the base projection is held in the socket recess, and
the pad portion is disposed away from an outer surface of the body,
wherein the body includes a switch actuating projection opening, wherein the switch actuating projection opening is configured to receive the switch actuating projection therein,
a paddle switch, wherein the paddle switch
is positioned within the body,
includes a paddle switch actuator, wherein the paddle switch actuator is in aligned relation with the switch actuating projection opening,
is changeable between a first paddle switch condition and a second paddle switch condition responsive to movement of the paddle switch actuator,
wherein movement of the pad portion toward the outer surface of the body is operative to cause the switch actuating projection move within the switch actuating projection opening and to operatively move the paddle switch actuator such that the paddle switch is caused to change from the first paddle switch condition to the second paddle switch condition.

10. The apparatus according to claim 1
and further comprising:
a pair of paddles, wherein each paddle includes
a base portion, wherein the base portion includes an inner facing side and an outer facing side, wherein a base projection extends from the inner facing side,
a finger engageable pad portion, wherein the pad portion is disposed away from the base portion and is configured for movement responsive to finger engagement therewith,
an arm portion, wherein the arm portion extends intermediate of the base portion and the pad portion, wherein the arm portion includes a switch actuating projection intermediate of the base portion and the pad portion,
wherein the body further includes a socket, wherein the socket includes
a pair of socket channels, wherein a respective base portion extends in a respective socket channel, and
a pair of socket recesses, wherein a respective base projection of a respective paddle is engaged in the respective socket recess,
wherein when the respective base portion of a respective paddle is engaged in a respective socket channel and the base projection of the respective paddle is engaged in a respective socket recess, the arm portion and the pad portion of the respective paddle are disposed away from the socket,
a socket cover, wherein the socket cover is releasably engageable with the socket,
wherein when the socket cover is engaged with the socket
the base portion of each of the paddles is held in intermediate relation between the socket cover and the socket,
the respective base projection of each respective paddle is held in a respective socket recess,
the pad portions are angularly disposed away from one another, and
the respective pad portion of each respective paddle is disposed away from an outer surface of the body,
a pair of paddle switches, wherein each paddle switch
includes a paddle switch actuator,
is changeable between a first paddle switch condition and a second paddle switch condition responsive to movement of the paddle switch actuator,
wherein movement of a respective pad portion of a respective paddle toward the outer surface of the body is operative to cause the respective switch actuating projection of a respective paddle to move a respective paddle switch actuator such that the respective paddle switch is caused to change from the first paddle switch condition to the second paddle switch condition.

11. The apparatus according to claim 1
and further comprising:
a pair of paddles, wherein each paddle includes a
a base portion, wherein the base portion includes an inner facing side and an outer facing side, wherein a base projection extends from the inner facing side,
a finger engageable pad portion, wherein the pad portion is disposed away from the base portion and is configured for movement responsive to finger engagement therewith,
an arm portion, wherein the arm portion extends intermediate of the base portion and the pad portion, wherein the arm portion includes a switch actuating projection intermediate of the base portion and the pad portion,
wherein the body further includes a socket, wherein the socket includes
a pair of socket channels, wherein a respective base portion extends in a respective socket channel, and
a pair of socket recesses, wherein a respective base projection of a respective paddle is engaged in the respective socket recess,
wherein when the respective base portion of a respective paddle is engaged in a respective socket channel and the base projection of the paddle is engaged in a respective socket recess, the arm portion and the pad portion of the respective paddle are disposed away from the socket,
a socket cover, wherein the socket cover is releasably engageable with the socket,
wherein when the socket cover is engaged with the socket
the base portion of each of the paddles is held in intermediate relation between the socket cover and the socket,
the respective base projection of each respective paddle is held in a respective socket recess,
the pad portions are angularly disposed away from one another, and
the respective pad portion of each respective paddle is disposed away from an outer surface of the body,
a pair of paddle switches, wherein each paddle switch
includes a paddle switch actuator,
is changeable between a first paddle switch condition and a second paddle switch condition responsive to movement of the paddle switch actuator,
wherein movement of a respective pad portion of a respective paddle toward the outer surface of the body is operative to cause the responsive switch actuating projection of a respective paddle to move a respective paddle switch actuator such that the respective paddle switch is caused to change from the first paddle switch condition to the second paddle switch condition,
and wherein when the socket cover is disengaged from the socket the base portions of each of the paddles is disengageable from the socket, whereby each of the paddles is disengageable from the body.

12. The apparatus according to claim 1
and further comprising:
four paddles, wherein each paddle includes
a base portion, wherein the base portion includes an inner facing side and outer facing side, wherein a base projection extends from the inner facing side,
a finger engageable pad portion, wherein the pad portion is disposed away from the base portion and is configured for movement responsive to finger engagement therewith,
an arm portion, wherein the arm portion extends intermediate of the base portion and the pad portion, wherein the arm portion includes a switch actuating projection intermediate of the base portion and the pad portion,
wherein the body further includes a socket, wherein the socket includes
four disposed socket channels, wherein a respective base portion of a respective paddle extends in a respective socket channel, and
four socket recesses, wherein a respective base projection of a respective paddle is engaged in the respective socket recess,
wherein when the respective base portion of a respective paddle is engaged in a respective socket channel and the base projection of the paddle is engaged in a respective socket recess, the arm portion and the pad portion of the respective paddle are disposed away from the socket,
a socket cover, wherein the socket cover is releasably engageable with the socket,
wherein when the socket cover is engaged with the socket
the base portion of each of the four paddles is held in intermediate relation between the socket cover and the socket,
the respective base projection of each of the four respective paddles is held in a respective socket recess,
the pad portions of each of the paddles are angularly disposed away from one another, and
the respective pad portion of each respective paddle is disposed away from an outer surface of the body,
four paddle switches, wherein each paddle switch
includes a paddle switch actuator,
is changeable between a first paddle switch condition and a second paddle switch condition responsive to movement of the paddle switch actuator,
wherein for each paddle switch, movement of a respective pad portion of a respective paddle toward the outer surface of the body is operative to cause the respective switch actuating projection of the respective paddle to operatively move the respective paddle switch actuator such that the respective paddle switch is caused to change from the first paddle switch condition to the second paddle switch condition.

13. The apparatus according to claim 1
and further comprising:
a body overlay, wherein the body overlay is configured to releasably overlie a portion of the body,
wherein changing the body overlay changes at least one of appearance and tactile properties of the body.

14. The apparatus according to claim 1
wherein the body includes a plurality of disposed body magnets,
and further comprising:
a body overlay, wherein the body overlay
is configured to releasably overlie a portion of the body, and
includes a plurality of disposed overlay magnets, wherein each overlay magnet is configured to be positioned adjacent to a respective body magnet when the body overlay is installed on the body,
wherein changing the body overlay changes at least one of an appearance and a tactile property of the body.

15. The apparatus according to claim 1
wherein the body includes a touch panel, wherein the touch panel is configured to provide visual outputs and to receive contact inputs,
and further comprising:
an overlay, wherein the overlay is operative to releasably overlie the touch panel.

16. The apparatus according to claim 1
wherein the body includes
a plurality of disposed body magnets, and
a touch panel, wherein the touch panel is configured to provide visual outputs and to receive contact inputs,
and further comprising:
an overlay, wherein the overlay
is configured to overlie the touch panel, and
includes a plurality of overlay magnets, wherein each of the overlay magnets is adjacent to a respective body magnet when the overlay is in overlying relation of the touch panel.

17. The apparatus according to claim 1
and further comprising:
a manually actuatable button, wherein the manually actuatable button is manually movable on the body, wherein movement of the manually actuatable button is operative to change a condition of a button switch,
a paddle, wherein the paddle includes
a base portion, wherein the base portion includes an inner facing side and outer facing side, wherein a base projection extends from the inner facing side,
a finger engageable pad portion, wherein the pad portion is disposed away from the base portion and is configured to move responsive to finger engagement therewith,
an arm portion, wherein the arm portion extends intermediate of the base portion and the pad portion, wherein the arm portion includes a switch actuating projection intermediate of the base portion and the pad portion,
wherein the body further includes a socket, wherein the socket includes
a socket channel, wherein the base portion extends in the socket channel, and
a socket recess, wherein the base projection is engaged in the socket recess,
wherein when the base portion is engaged in the socket channel and the base projection is engaged in the socket recess, the arm and the pad portion are disposed away from the socket,
a socket cover, wherein the socket cover is releasably engageable with the socket,
wherein when the socket cover is engaged with the socket
the base portion is held in intermediate relation between the socket cover and the socket,
the base projection is held in the socket recess, and
the pad portion is disposed away from an outer surface of the body,
a paddle switch, wherein the paddle switch
includes a paddle switch actuator,
is changeable between a first paddle switch condition and a second paddle switch condition responsive to movement of the paddle switch actuator,
wherein movement of the pad portion toward the outer surface of the body is operative to cause the switch actuating projection to operatively move the paddle switch actuator such that the paddle switch is caused to change from the first paddle switch condition to the second paddle switch condition,
circuitry housed within the body, wherein the circuitry is operative responsive at least in part to actuation of the paddle switch to cause actuation of the paddle switch to provide a controller input that is used by the circuitry in place of a signal caused by actuation of the button switch.

18. Apparatus comprising:
a video game controller configured to receive user inputs in conjunction with video game activity, including
a body,
a pair of finger movable triggers, wherein each of the triggers is in operatively supported connection with the body and disposed away from the other trigger on the body,
wherein each trigger is
finger movable relative to the body,
finger movable in a constrained trigger range of movement along a trigger movement direction responsive to finger contact with the trigger between a first trigger position and a second trigger position that is disposed away from the first trigger position,
circuitry, wherein the circuitry is
housed within the body,
in operative connection with each respective trigger,
operative to cause to be determined each current position of the respective trigger within the range of movement,
a pair of trigger stop switches, wherein each trigger stop switch
is housed within the body,
includes an actuator that is
movable between a first actuator position and a second actuator position,
operative to provide at least one circuit receivable signal indicative of whether the actuator is in the first actuator position or the second actuator position,
a pair of links, wherein each link
is movably mounted within the body between a first link position and a second link position,
wherein in the first link position the link does not cause operative engagement between a respective trigger and a respective actuator of a respective trigger stop switch when the respective trigger is positioned anywhere within the trigger range of movement,
wherein in the second link position the link causes the respective trigger and the respective actuator of the respective trigger stop switch to be operatively engaged such that when the respective trigger is moved from the first trigger position to a stop position which corresponds to only a portion of the trigger range of movement from the first trigger position toward the second trigger position, the respective trigger is
prevented from moving further toward the second trigger position, and
operative to cause the respective actuator to be moved from the first actuator position to the second actuator position,
at least one input device, wherein the at least one input device is
manually accessible from outside the body,
manually movable from outside the body between a first input device position and a second input device position,
in operative connection with at least one link,
wherein in the first input device position the at least one link is caused to be in the first link position, and in the second input device position the at least one link is caused to be in the second link position.

19. The apparatus according to claim 18
and further including:
a pair of position sensors, wherein each position sensor is
housed within the body,
is in operative connection with a respective trigger,
is operative to provide at least one signal to the circuitry indicative of each current position of the respective trigger within the trigger range of movement.

20. The apparatus according to claim 19
wherein the at least one input device includes two input devices, wherein one respective input device is in operative connection with one respective link, and wherein each input device comprises one of
a slidable button,
a rotatable knob, or
a movable projection.

21. The apparatus according to claim 20
wherein each stop switch actuator is operative to cause a respective trigger to receive a tactilely perceivable click responsive to the respective stop switch actuator moving to the second actuator position responsive to trigger movement.

22. The apparatus according to claim 21
and further comprising:
at least one paddle, wherein each paddle includes
a base portion, wherein the base portion includes an inner facing side and an outer facing side, wherein a base projection extends on at least one of the inner facing side and the outer facing side,
a finger displaceable pad portion, wherein the pad portion is disposed away from the base portion and is configured to move responsive to finger engagement with the pad portion,
an arm portion, wherein the arm portion extends intermediate of the base portion and the pad portion, wherein the arm portion includes a switch actuating projection intermediate of the base portion and the pad portion,
wherein the body further includes a socket, wherein the socket includes
at least one socket recess, wherein the respective base projection of each respective paddle is engaged in a respective socket recess,
wherein when the base projection of a respective paddle is engaged in a respective socket recess, the arm portion and the pad portion of the paddle are disposed outwardly away from the socket,
a releasably engageable socket cover, wherein when the socket cover is engaged with the socket,
the base portion of each paddle is held in intermediate relation between the socket cover and the socket with the respective base projection in the socket recess, and
the pad portion of the respective paddle is disposed away from an outer surface of the body away from the socket,
at least one paddle switch, wherein each paddle switch
includes a paddle switch actuator,
is changeable between a first paddle switch condition and a second paddle switch condition responsive to movement of the paddle switch actuator,
wherein movement of the respective pad portion of a respective paddle toward the outer surface of the body is operative to cause a respective switch actuating projection to operatively move the paddle switch actuator of a respective paddle switch such that the paddle switch is caused to change from the first paddle switch condition to the second paddle switch condition.

23. The apparatus according to claim 22
wherein when the socket cover is disengaged from the socket, the base portion of each paddle is removable from engagement with the socket, whereby each of the paddles is disengageable from the body.

24. The apparatus according to claim 23
wherein the body includes a plurality of disposed body magnets,
and further including:
a body overlay, wherein the body overlay
is configured to releasably overly a portion of the body, and
includes a plurality of disposed overlay magnets, wherein each overlay magnet is configured to be positioned adjacent to a respective body magnet when the body overlay is installed on the body
wherein changing the body overlay changes at least one of an appearance property and a tactile property of the body.
